(19) United States
(12) Patent Application Publication
(10) Pub. No.: US 2025/0306303 A1
(43) Pub. Date: Oct. 2, 2025

(54) PHOTONIC INTEGRATED CIRCUIT PACKAGES INCLUDING AN ON-PACKAGE EXPANDED BEAM CONNECTOR FOR DETACHABLE FIBER ARRAY

(71) Applicant: Intel Corporation, Santa Clara, CA (US)

(72) Inventors: Li Yuan, Fremont, CA (US); Ziyin Lin, Chandler, AZ (US); Kumar Abhishek Singh, Phoenix, AZ (US); Saikumar Jayaraman, Chandler, AZ (US)

(73) Assignee: Intel Corporation, Santa Clara, CA (US)

(21) Appl. No.: 18/616,512

(22) Filed: Mar. 26, 2024

(51) Int. Cl. G02B 6/42

(52) U.S. Cl. CPC G02B 6/423; G02B 6/4206

(57) ABSTRACT

Photonic IC packages, related devices and methods, are disclosed herein. In some embodiments, a photonic package may include a substrate; a photonic integrated circuit (PIC) having a first optical element, the PIC coupled to the substrate; a connector including a fiber alignment structure; and a second optical element, wherein the second optical element is to expand and collimate an optical beam, and wherein a material of the connector includes a 3-dimensional (3D) printing optical polymer, a 3D printing grade glass, a 3D printing optical resin, a fused silica glass, or an optical grade polymer; and a fiber having a first end and an opposing second end, wherein the fiber is positioned in the fiber alignment structure, and wherein the first end of the fiber is optically coupled to the first optical element and the second end of the fiber is optically coupled to the second optical element.

### BACKGROUND

The present disclosure relates to integrated circuits (ICs) including components for optical communications, such as photonic integrated circuits (PICs). More specifically, it relates to techniques, methods, and apparatus directed to packaging architecture including connectors for expanded beam coupling to PICs.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A is a schematic cross-sectional view of an example photonic package according to some embodiments of the present disclosure.

FIG. 1B is a schematic illustration of an example detail of an active surface of a photonic integrated circuit according to some embodiments of the present disclosure.

FIG. 2A is a schematic cross-sectional view of another example photonic package according to some embodiments of the present disclosure.

FIG. 2B is a schematic perspective view of the example IC package of FIG. 2A according to some embodiments of the present disclosure.

FIG. 3 is a schematic cross-sectional view of another example photonic package according to some embodiments of the present disclosure.

FIG. 4 is a schematic cross-sectional view of yet another example photonic package according to some embodiments of the present disclosure.

FIG. 5A is a perspective view of an example expanded beam connector according to some embodiments of the present disclosure.

FIG. 5B is an expanded perspective view of the example expanded beam connector of FIG. 5A according to some embodiments of the present disclosure.

FIG. 5C is a schematic cross-sectional, front view of the expanded beam connector of FIG. 5A according to some embodiments of the present disclosure.

FIG. 5D is a schematic cross-sectional, front view of an example expanded beam connector according to some embodiments of the present disclosure.

FIG. 6A is a perspective view of some components of the example IC package of FIG. 2A prior to coupling according to some embodiments of the present disclosure.

FIG. 6B is a perspective view of the components of FIG. 6A after coupling and attaching a fastener according to some embodiments of the present disclosure.

FIGS. 7A and 7B are schematic perspective views of a pair of example expanded beam connectors according to some embodiments of the present disclosure.

FIG. 7C is a schematic cross-sectional, front view of the expanded beam connector of FIG. 7A according to some embodiments of the present disclosure.

FIG. 8A is a perspective view of some components of the example IC package of FIG. 2A according to some embodiments of the present disclosure.

FIG. 8B is a perspective view of the components of FIG. 8A after coupling and attaching a fastener according to some embodiments of the present disclosure.

FIG. 9 is a block diagram of an example computing device that includes one or more microelectronic assemblies in accordance with any of the embodiments disclosed herein.

### DETAILED DESCRIPTION

For purposes of illustrating photonic IC packages described herein, it is important to understand phenomena that may come into play during assembly and packaging of PICs. The following foundational information may be viewed as a basis from which the present disclosure may be properly explained. Such information is offered for purposes of explanation only and, accordingly, should not be construed in any way to limit the broad scope of the present disclosure and its potential applications. Advances in semiconductor processing and logic design have permitted an increase in the amount of logic circuits that may be included in processors and other IC devices. Current technologies permit hundreds and thousands of such active circuit elements to be formed on a single die so that numerous logic circuits may be enabled thereon. Similarly, off-package input/output (I/O) bandwidth has been steadily doubling every couple of years. IC packaging and I/O technologies continuously scale to meet the increased bandwidth demand. As a result, package pin counts and I/O data rates continue to increase. However, electrical I/O reach (e.g., length of electrical trace) continues to reduce at increased data rates. One solution to overcome these limitations is to implement optical transmission of signals.

Integrating optical communications to IC packages further increases the complexity. Contemporary optical communications and other systems often employ PICs. Smaller, faster, and less expensive optical elements can enable universal, low-cost, high-volume optical communications needed for fast and efficient communication technologies demanded by high volume internet data traffic. In optical communications, information is transmitted by way of an optical carrier whose frequency typically is in the visible or near-infrared region of the electromagnetic spectrum. A carrier with such a high frequency is sometimes referred to as an optical signal, an optical carrier, a light wave signal, or simply light. A typical optical communications network includes several optical fibers, each of which may include several channels. A channel is a specified frequency band of an electromagnetic signal and is sometimes referred to as a wavelength. Technological advances today enable implementing portions of optical communication systems at the IC (or chip or die) level in PICs. Packaging such PICs presents many challenges.

In a general sense, a PIC integrates photonic functions for information signals imposed on electromagnetic waves, e.g., electromagnetic waves of optical wavelengths. PICs find application in fiber-optic communication, medical, security, sensing, and photonic computing systems. PIC may implement one or more optical and electro-optical devices such as lasers, photodetectors, waveguides, and modulators on a single semiconductor chip. In addition, PIC may also include electrical circuitry to process electrical signals corresponding to these optical signals. Such integrated PICs have both photonic processing and electrical signal processing in a same process node which may limit optimization. In other embodiments, PIC may be in a separate process node that optimizes PIC performance and electrical signal processing may be in a different process node that optimizes the electrical high-speed performance.

Packaging a PIC is not trivial. Among the challenges is a need for parallel tight-pitch interconnects that enable high density, high bandwidth electrical communication between a PIC and other electrical devices, such as processor integrated circuits (XPU), also referred to herein as “processor IC,” and electrical integrated circuits (EIC) with simultaneous optical access to a PIC for the optical signals. Indeed, exchanging optical signals between a PIC and an external source can be difficult and is a main driver of manufacturing cost and complexity. PIC are typically exposed in the package to allow the fiber to be coupled to a PIC with sufficient stability even in such edge-coupled assemblies. For example, in some packaging architectures, a PIC has an overhang to couple to the fiber which presents at the edge of the package. Typically, the optical connections include optical fibers that are mounted to fiber alignment region, for example, v-groove channels, on the edge of a PIC by a “fiber array unit” (FAU), where the optical fibers include a pigtail design that is terminated with a multi-channel (MT) type optical fiber ferrule. For routing optical signals, the alignment between optical components is crucial to ensure efficient transmission of optical signals with low loss. One approach to assure good alignment of optical signals is to position a fiber into a V-shaped groove that aligns to an optical waveguide of a PIC and securing the fiber in the V-shaped groove with a resin or an adhesive that surrounds the fiber. For example, V-shaped grooves are etched into a PIC, the fibers are put in a jig and pressed into the grooves. If the fibers are slightly misaligned, the shape of the grooves aligns the fibers are pressed down.

Package handling and surface mount technology (SMT) is challenging with the pigtail type connector. Fiber pigtails are fragile and susceptible to cracking, which presents manufacturing and handling challenges that commonly result in reduced yields and end-of-use failures. For example, there may be up to 24 fibers per PIC and up to 6 PIC per package. If an optical signal fails due to a misalignment or breakage, the fibers, the PIC, and, often, other IC components, must be discarded, which severely impacts manufacturing by decreasing yields and increasing costs. A single fiber alignment issue may lead to a defective unit which is a large waste for die/package/assembly processes. Additionally, the chosen length for the standard pigtail may not be ideal in certain platform situations. A non-ideal pigtail length would require extra bends and/or extra connections, and result in added link loss. Furthermore, automation for high volume manufacturing (HVM) is challenging with pigtail and MT ferrules, which frequently require manual handling and plugging/unplugging.

Structures and methods that enable fiber pigtail type connectors to be attached/detached for in-process testing, then reattached subsequent to IC package assembly and that are compatible with existing production processes, for example, the utilization of V-shaped grooves and the ability to tolerate solder reflow temperature ranges may be desired. Further, structures that may be readily cleaned, for example, by an air blow process to remove dust and/or contaminants may be desired as well.

Accordingly, embodiments disclosed herein include paired attachable/detachable fiber array connectors for expanded beam coupling to on-package optics, where one connector is on-package and the other connector (e.g., that includes the fiber pigtails) is off-package, such that the off-package fiber array connector may be connected to the on-package fiber array connector subsequent to the assembly of the photonic package. For example, a photonic package may include a PIC, an on-package connector with a first fiber alignment structure and first expanded beam optical components, and an on-package fiber array having individual fibers with a first end optically coupled to the PIC and an opposing second end terminating in the on-package connector and optically coupled to individual ones of the first expanded beam optical components. Embodiments disclosed herein may further include an off-package connector with a second fiber alignment structure and second expanded beam optical components, and an off-package fiber array having individual fibers with a first end optically coupled to an optical fiber ferrule and an opposing second end terminating in the off-package connector and optically coupled to individual ones of the second expanded beam optical components, where the off-package connector is connected to the on-package connector and enables expanded beam coupling. That is, the paired EB connectors are optically coupled (e.g., a first expanded beam optical component on the on-package connector and a second expanded beam optical component on the off-package connector) to allow for the optical beam to be collimated and expanded at the interface.

Accordingly, photonic IC packages, related devices and methods, are disclosed herein. In some embodiments, a photonic package may include a substrate; a photonic integrated circuit (PIC) having a first optical element, the PIC coupled to the substrate; a connector including a fiber alignment structure; and a second optical element, wherein the second optical element is to expand and collimate an optical beam, and wherein a material of the connector includes a 3-dimensional (3D) printing optical polymer, a 3D printing grade glass, a 3D printing optical resin, a fused silica glass, or an optical grade polymer; and a fiber having a first end and an opposing second end, wherein the fiber is positioned in the fiber alignment structure, and wherein the first end of the fiber is optically coupled to the first optical element and the second end of the fiber is optically coupled to the second optical element.

An example photonic IC package architecture disclosed herein may further include coupling a plurality of PICs, EICs, PICs, and/or interconnect dies using high-density interconnects, such as hybrid bonding. As used herein, “high-density interconnects” include interconnects having a pitch of less than 10 microns. As used herein, pitch is measured center-to-center (e.g., from a center of an interconnect to a center of an adjacent interconnect). The terms “interconnect die,” “bridge die,” “bridge,” “interconnect bridge” may be used interchangeably herein.

Each of the structures, assemblies, packages, methods, devices, and systems of the present disclosure may have several innovative aspects, no single one of which is solely responsible for all the desirable attributes disclosed herein. Details of one or more implementations of the subject matter described in this specification are set forth in the description below and the accompanying drawings.

In the following detailed description, various aspects of the illustrative implementations may be described using terms commonly employed by those skilled in the art to convey the substance of their work to others skilled in the art.

The terms “circuit” and “circuitry” mean one or more passive and/or active electrical and/or electronic components that are arranged to cooperate with one another to provide a desired function. The terms also refer to analog circuitry, digital circuitry, hard wired circuitry, programmable circuitry, microcontroller circuitry and/or any other type of physical hardware electrical and/or electronic component.

The term “integrated circuit” means a circuit that is integrated into a monolithic semiconductor or analogous material.

In some embodiments, the IC dies disclosed herein may comprise substantially monocrystalline semiconductors, such as silicon or germanium, as a base material (e.g., substrate, body) on which integrated circuits are fabricated with traditional semiconductor processing methods. The semiconductor base material may include, for example, N-type or P-type materials. Dies may include, for example, a crystalline base material formed using a bulk silicon (or other bulk semiconductor material) or a silicon-on-insulator (SOI) structure. In some other embodiments, the base material of one or more of the IC dies may comprise alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-N, group Ill-V, group II-VI, or group IV materials. In yet other embodiments, the base material may comprise compound semiconductors, for example, with a first sub-lattice of at least one element from group III of the periodic table (e.g., Al, Ga, In), and a second sub-lattice of at least one element of group V of the periodic table (e.g., P, As, Sb). In yet other embodiments, the base material may comprise an intrinsic IV or III-V semiconductor material or alloy, not intentionally doped with any electrically active impurity; in alternate embodiments, nominal impurity dopant levels may be present. In still other embodiments, dies may comprise a non-crystalline material, such as polymers; for example, the base material may comprise silica-filled epoxy. In other embodiments, the base material may comprise high mobility oxide semiconductor material, such as tin oxide, antimony oxide, indium oxide, indium tin oxide, titanium oxide, zinc oxide, indium zinc oxide, indium gallium zinc oxide (IGZO), gallium oxide, titanium oxynitride, ruthenium oxide, or tungsten oxide. In general, the base material may include one or more of tin oxide, cobalt oxide, copper oxide, antimony oxide, ruthenium oxide, tungsten oxide, zinc oxide, gallium oxide, titanium oxide, indium oxide, titanium oxynitride, indium tin oxide, indium zinc oxide, nickel oxide, niobium oxide, copper peroxide, IGZO, indium telluride, molybdenite, molybdenum diselenide, tungsten diselenide, tungsten disulfide, N- or P-type amorphous or polycrystalline silicon, germanium, indium gallium arsenide, silicon germanium, gallium nitride, aluminum gallium nitride, indium phosphide, and black phosphorus, each of which may possibly be doped with one or more of gallium, indium, aluminum, fluorine, boron, phosphorus, arsenic, nitrogen, tantalum, tungsten, and magnesium, etc. Although a few examples of the material for dies are described here, any material or structure that may serve as a foundation (e.g., base material) upon which IC circuits and structures as described herein may be built falls within the spirit and scope of the present disclosure.

Unless described otherwise, IC dies described herein include one or more IC structures (or, simply, “ICs”) implementing (i.e., configured to perform) certain functionality. In one such example, the term “memory die” may be used to describe a die that includes one or more ICs implementing memory circuitry (e.g., ICs implementing one or more of memory devices, memory arrays, control logic configured to control the memory devices and arrays, etc.). In another such example, the term “compute die” may be used to describe a die that includes one or more ICs implementing logic/compute circuitry (e.g., ICs implementing one or more of I/O functions, arithmetic operations, pipelining of data, etc.).

In another example, the terms “package” and “IC package” are synonymous, as are the terms “die” and “IC die.” Note that the terms “chip,” “chiplet,” “die,” and “IC die” are used interchangeably herein.

The term “insulating” means “electrically insulating,” the term “conducting” means “electrically conducting,” unless otherwise specified. With reference to optical signals and/or devices, components and elements that operate on or using optical signals, the term “conducting” can also mean “optically conducting.”

The terms “oxide,” “carbide,” “nitride,” etc. refer to compounds containing, respectively, oxygen, carbon, nitrogen, etc.

The term “high-k dielectric” refers to a material having a higher dielectric constant than silicon oxide, while the term “low-k dielectric” refers to a material having a lower dielectric constant than silicon oxide.

The term “insulating material” or “insulator” (also called herein as “dielectric material” or “dielectric”) refers to solid materials (and/or liquid materials that solidify after processing as described herein) that are substantially electrically nonconducting. They may include, as examples and not as limitations, organic polymers and plastics, and inorganic materials such as ionic crystals, porcelain, glass, silicon, silicon oxide, silicon carbide, silicon carbonitride, silicon nitride, and alumina or a combination thereof. They may include dielectric materials, high polarizability materials, and/or piezoelectric materials. A dielectric material may include any suitable dielectric material commonly used in semiconductor manufacture, such as silicon and one or more of oxygen, nitrogen, hydrogen, and carbon (e.g., in the form of silicon oxide, silicon nitride, silicon oxynitride, or silicon carbon nitride); a polyimide material; or a low-k or ultra low-k dielectric (e.g., carbon-doped dielectrics, fluorine-doped dielectrics, porous dielectrics, organic polymeric dielectrics, photo-imageable dielectrics, and/or benzocyclobutene-based polymers). They may be transparent or opaque without departing from the scope of the present disclosure. Further examples of insulating materials are underfills and molds or mold-like materials used in packaging applications, including for example, materials used in organic interposers, package supports and other such components.

In various embodiments, elements associated with an IC may include, for example, transistors, diodes, power sources, resistors, capacitors, inductors, sensors, transceivers, receivers, antennas, etc. In various embodiments, elements associated with an IC may include those that are monolithically integrated within an IC, mounted on an IC, or those connected to an IC. The ICs described herein may be either analog or digital and may be used in a number of applications, such as microprocessors, optoelectronics, logic blocks, audio amplifiers, etc., depending on the components associated with the IC. The ICs described herein may be employed in a single IC die or as part of a chipset for executing one or more related functions in a computer.

In various embodiments of the present disclosure, transistors described herein may be field-effect transistors (FETs), e.g., MOSFETs. In many embodiments, an FET is a four-terminal device. In silicon-on-insulator, or nanoribbon, or gate all-around (GAA) FET, the FET is a three-terminal device that includes source, drain, and gate terminals and uses electric field to control current flowing through the device. A FET typically includes a channel material, a source region and a drain regions provided in and/or over the channel material, and a gate stack that includes a gate electrode material, alternatively referred to as a “work function” material, provided over a portion of the channel material (the “channel portion”) between the source and the drain regions, and optionally, also includes a gate dielectric material between the gate electrode material and the channel material.

In a general sense, an “interconnect” refers to any element that provides a physical connection between two other elements. For example, an electrical interconnect provides electrical connectivity between two electrical components, facilitating communication of electrical signals between them; an optical interconnect provides optical connectivity between two optical components, facilitating communication of optical signals between them. As used herein, both electrical interconnects and optical interconnects are comprised in the term “interconnect.” The nature of the interconnect being described is to be understood herein with reference to the signal medium associated therewith. Thus, when used with reference to an electronic device, such as an IC that operates using electrical signals, the term “interconnect” describes any element formed of an electrically conductive material for providing electrical connectivity to one or more elements associated with the IC or/and between various such elements. In such cases, the term “interconnect” may refer to both conductive traces (also sometimes referred to as “lines,” “wires,” “metal lines” or “trenches”) and conductive vias (also sometimes referred to as “vias” or “metal vias”). Sometimes, electrically conductive traces and vias may be referred to as “conductive traces” and “conductive vias”, respectively, to highlight the fact that these elements include electrically conductive materials such as metals. Likewise, when used with reference to a device that operates on optical signals as well, such as a PIC, “interconnect” may also describe any element formed of a material that is optically conductive for providing optical connectivity to one or more elements associated with the PIC. In such cases, the term “interconnect” may refer to optical waveguides, including optical fiber, optical splitters, optical combiners, optical couplers, and optical vias.

As used herein, the term “optical element” includes arrangements of forms fabricated in ICs to receive, transform and/or transmit optical signals as described herein. It may include optical conductors such as waveguides, grating coupler, electromagnetic radiation sources such as lasers, and electro-optical devices such as photodetectors.

The term “waveguide” refers to any structure that acts to guide the propagation of light from one location to another location typically through a substrate material such as silicon or glass. In various examples, waveguides can be formed from silicon, doped silicon, silicon nitride, glasses such as silica (e.g., silicon dioxide or SiO₂), borosilicate (e.g., 70-80 wt % SiO₂, 7-13 wt % of B₂O₃, 4-8 wt % Na₂O or K₂O, and 2-8 wt % of Al₂O₃) and so forth. Waveguides may be formed using various techniques including but not limited to forming waveguides in situ. For example, in some embodiments, waveguides may be formed in situ in glass using low temperature glass-to-glass bonding or by laser direct writing (e.g., a laser written waveguide). Waveguides formed in situ may have lower loss characteristics.

The term “conductive trace” may be used to describe an electrically conductive element isolated by an insulating material. Within IC dies, such insulating material comprises interlayer low-k dielectric that is provided within the IC die. Within package substrates, and printed circuit boards (PCBs) such insulating material comprises organic materials such as Ajinomoto Buildup Film (ABF), polyimides, or epoxy resin. Such conductive lines are typically arranged in several levels, or several layers, of metallization stacks.

The term “conductive via” may be used to describe an electrically conductive element that interconnects two or more conductive lines of different levels of a metallization stack. To that end, a via may be provided substantially perpendicularly to the plane of an IC die/chip or a support structure over which an IC structure is provided and may interconnect two conductive lines in adjacent levels or two conductive lines in non-adjacent levels.

The term “package substrate” may be used to describe any substrate material that facilitates the packaging together of any collection of semiconductor dies and/or other electrical components such as passive electrical components. As used herein, a package substrate may be formed of any material including, but not limited to, insulating materials such as resin impregnated glass fibers (e.g., PCB or Printed Wiring Boards (PWB)), glass, ceramic, silicon, silicon carbide, etc. In addition, as used herein, a package substrate may refer to a substrate that includes buildup layers (e.g., ABF layers).

The term “metallization stack” may be used to refer to a stack of one or more interconnects for providing connectivity to different circuit components of an IC die/chip and/or a package substrate.

As used herein, the term “pitch” of interconnects refers to a center-to-center distance between adjacent interconnects.

The terms “substantially,” “close,” “approximately,” “near,” and “about,” generally refer to being within +/−20% of a target value (e.g., within +/−5% or 10% of a target value) based on the context of a particular value as described herein or as known in the art.

Terms indicating orientation of various elements, e.g., “coplanar,” “perpendicular,” “orthogonal,” “parallel,” or any other angle between the elements, generally refer to being within +/−5%-20% of a target value based on the context of a particular value as described herein or as known in the art.

The term “connected” means a direct connection (which may be one or more of a mechanical, electrical, and/or thermal connection) between the things that are connected, without any intermediary devices, while the term “coupled” means either a direct connection between the things that are connected, or an indirect connection through one or more passive or active intermediary devices.

The description uses the phrases “in an embodiment” or “in embodiments,” which may each refer to one or more of the same or different embodiments.

Furthermore, the terms “comprising,” “including,” “having,” and the like, as used with respect to embodiments of the present disclosure, are synonymous.

The disclosure may use perspective-based descriptions such as “above,” “below,” “top,” “bottom,” and “side”; such descriptions are used to facilitate the discussion and are not intended to restrict the application of disclosed embodiments.

The terms “over,” “under,” “between,” and “on” as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with one or both of the two layers or may have one or more intervening layers. In contrast, a first layer described to be “on” a second layer refers to a layer that is in direct contact with that second layer. Similarly, unless explicitly stated otherwise, one feature disposed between two features may be in direct contact with the adjacent features or may have one or more intervening layers.

The term “dispose” as used herein refers to position, location, placement, and/or arrangement rather than to any particular method of formation.

The term “between,” when used with reference to measurement ranges, is inclusive of the ends of the measurement ranges.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used herein, the notation “A/B/C” means (A), (B), and/or (C).

Although certain elements may be referred to in the singular herein, such elements may include multiple sub-elements. For example, “an electrically conductive material” may include one or more electrically conductive materials. In another example, “a dielectric material” may include one or more dielectric materials.

Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale.

Coordinates, when included in the accompanying drawings, identify a thickness or a height by z-dimension, a length by x-dimension, and a width by y-dimension. A diameter or cross section may be identified by xy-dimension.

In the drawings, same reference numerals refer to the same or analogous elements/materials shown so that, unless stated otherwise, explanations of an element/material with a given reference numeral provided in context of one of the drawings are applicable to other drawings where element/materials with the same reference numerals may be illustrated. Further, the singular and plural forms of the labels may be used with reference numerals to denote a single one and multiple ones respectively of the same or analogous type, species, or class of element.

Furthermore, in the drawings, some schematic illustrations of example structures of various devices and assemblies described herein may be shown with precise right angles and straight lines, but it is to be understood that such schematic illustrations may not reflect real-life process limitations which may cause the features to not look so “ideal” when any of the structures described herein are examined using, e.g., images of suitable characterization tools such as scanning electron microscopy (SEM) images, transmission electron microscope (TEM) images, or non-contact profilometer. In such images of real structures, possible processing and/or surface defects could also be visible, e.g., surface roughness, curvature or profile deviation, pit or scratches, not-perfectly straight edges of materials, tapered vias or other openings, inadvertent rounding of corners or variations in thicknesses of different material layers, occasional screw, edge, or combination dislocations within the crystalline region(s), and/or occasional dislocation defects of single atoms or clusters of atoms. There may be other defects not listed here but that are common within the field of device fabrication and/or packaging.

Note that in the figures, various components (e.g., interconnects) are shown as aligned (e.g., at respective interfaces) merely for ease of illustration; in actuality, some or all of them may be misaligned. In addition, there may be other components, such as bond-pads, landing pads, metallization, etc. present in the assembly that are not shown in the figures to prevent cluttering. Further, the figures are intended to show relative arrangements of the components within their assemblies, and, in general, such assemblies may include other components that are not illustrated (e.g., various interfacial layers or various other components related to optical functionality, electrical connectivity, or thermal mitigation). For example, in some further embodiments, the assembly as shown in the figures may include more dies along with other electrical components. Additionally, although some components of the assemblies are illustrated in the figures as being planar rectangles or formed of rectangular solids, this is simply for ease of illustration, and embodiments of these assemblies may be curved, rounded, or otherwise irregularly shaped as dictated by and sometimes inevitable due to the manufacturing processes used to fabricate various components.

In the drawings, a particular number and arrangement of structures and components are presented for illustrative purposes and any desired number or arrangement of such structures and components may be present in various embodiments.

Further, unless otherwise specified, the structures shown in the figures may take any suitable form or shape according to material properties, fabrication processes, and operating conditions.

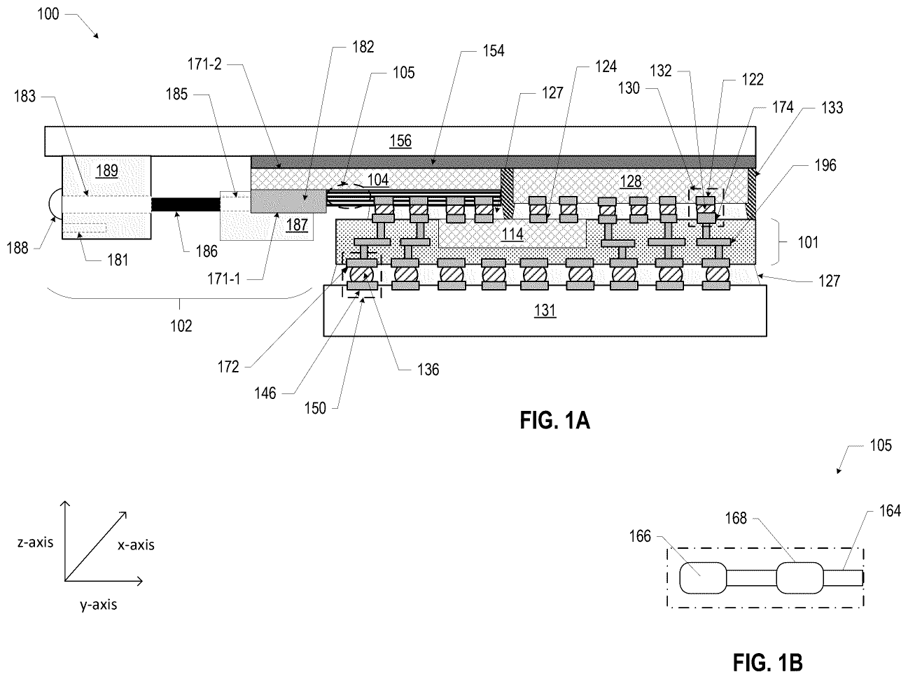

For convenience, if a collection of drawings designated with different letters are present (e.g., FIGS. 1A and 1B), such a collection may be referred to herein without the letters (e.g., as “FIG. 1”). Similarly, if a collection of reference numerals designated with different numerals or letters are present (e.g., 181-1, 181-2, 181-3, 181-4), such a collection may be referred to herein without the numerals or letters (e.g., as “181”).

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

As used herein, the terms “microelectronic assembly,” “photonic package,” “photonic microelectronic assembly,” and similar variations may be used interchangeably. As used herein, the term “optical pathway” refers to a path or trajectory by which light propagates from one location to another location through an optical medium. In some embodiments, an optical pathway may include one or more waveguides or other structures that guide the path of light or may include a passthrough structure. In some embodiments, the optical pathway may include a reflector, a mirror, a lens, or other component configured to transmit a beam from a vertical direction to a lateral direction or from a lateral direction to a vertical direction. in some embodiments, as described above, the optical pathway may include optical structures that allow for the optical beam to be collimated and expanded.

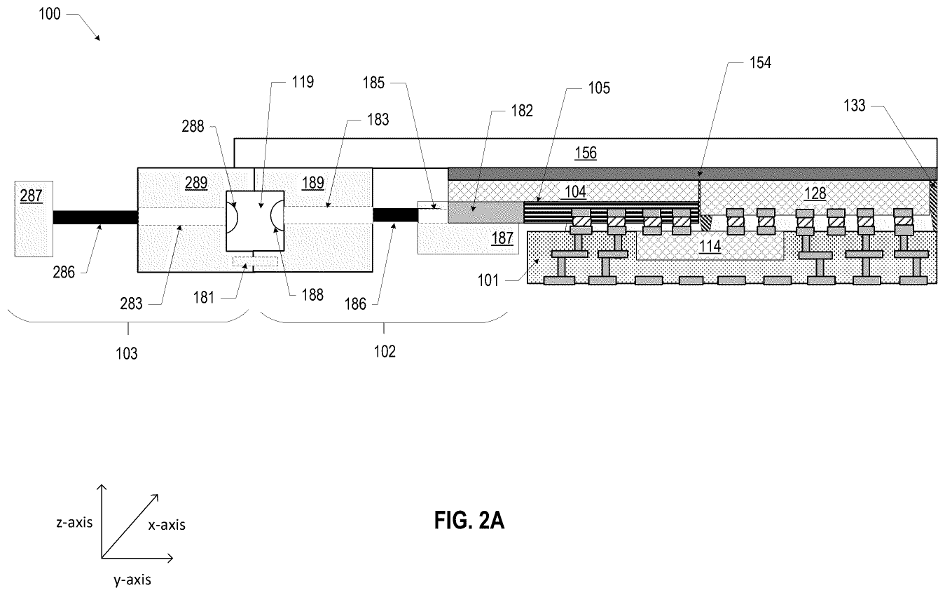

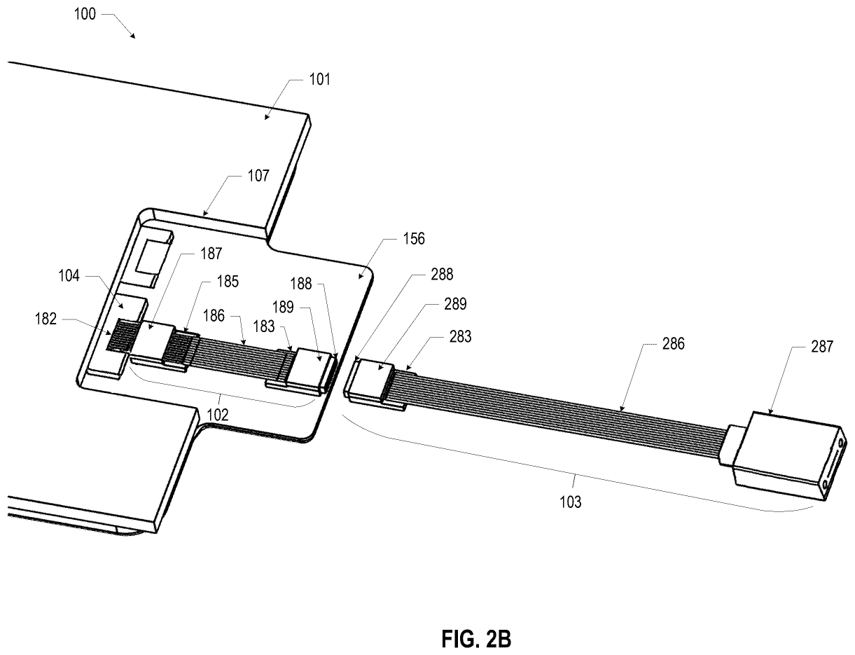

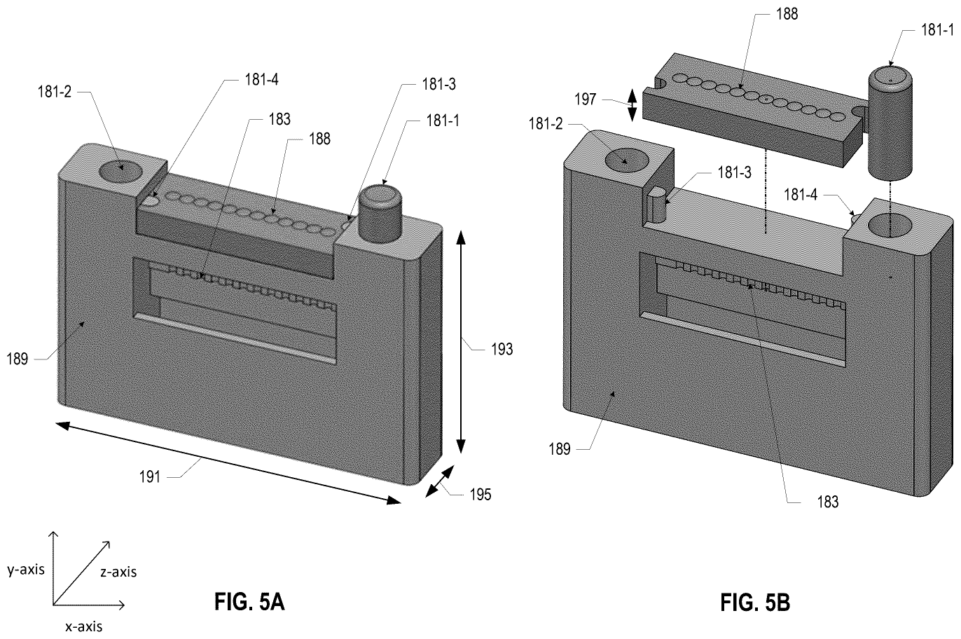

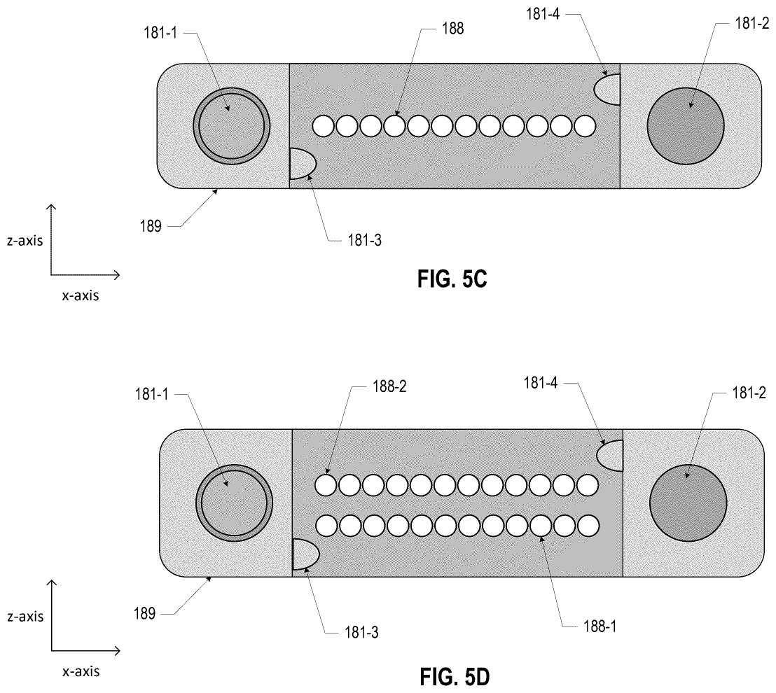

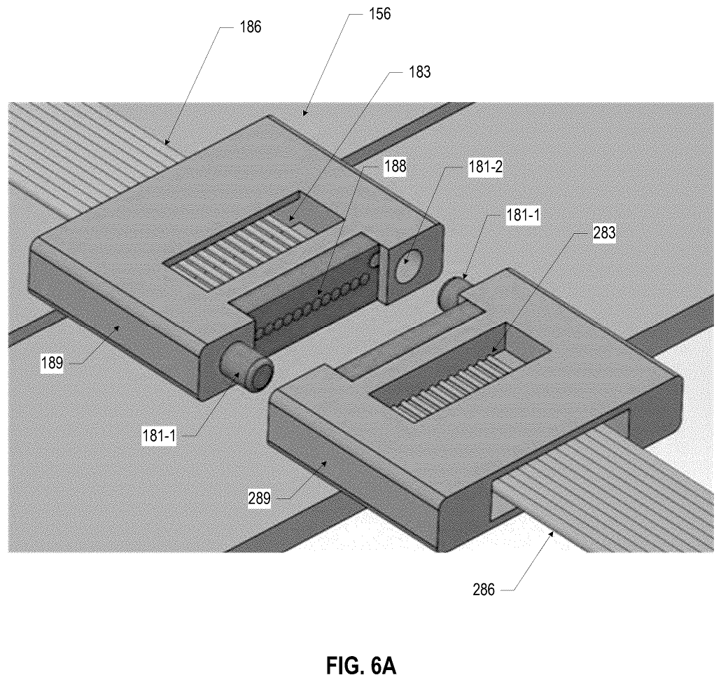

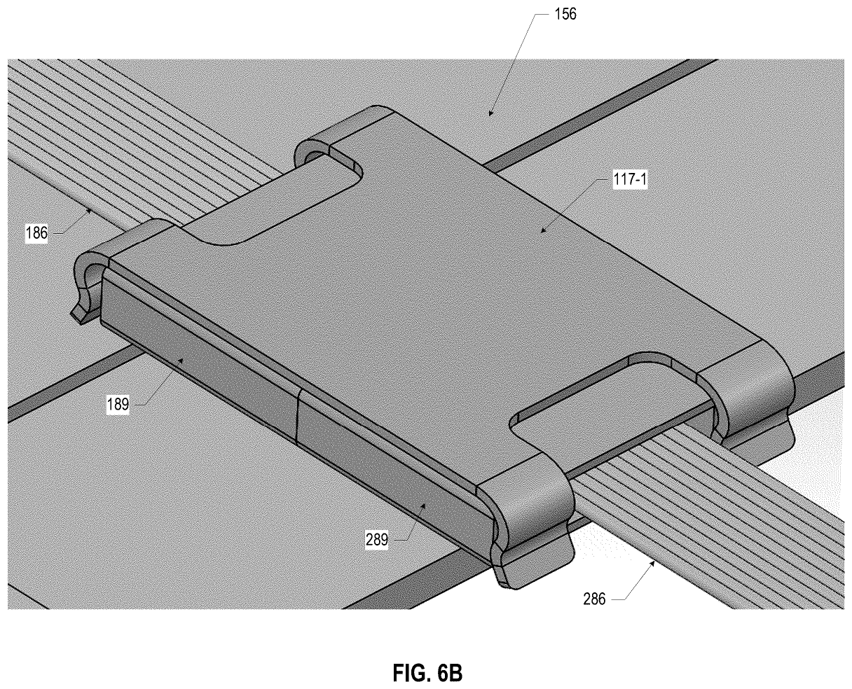

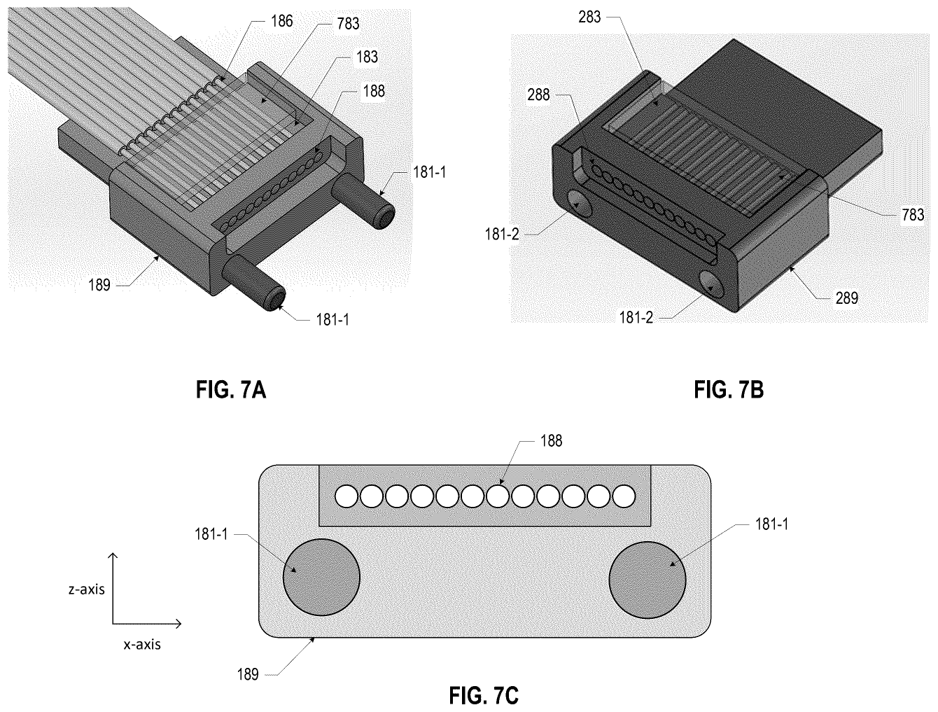

FIG. 1A is a schematic cross-sectional view of an example photonic package according to some embodiments of the present disclosure. Photonic package 100 comprises a PIC 104 including a fiber alignment region 182 to optically align a first end of a fiber 186 to an optical element (e.g., a waveguide 164, as described below with reference to FIG. 1B) and an on-package FAU 102 including a connector 189 having a fiber alignment structure 183 to optically align an opposing second end of a fiber 186 to an optical element 188 at a lateral surface of the connector 189, where the optical element 188 is to expand and collimate an optical beam. An optical element that expands and collimates an optical beam may also be referred to herein as “an expanded beam (EB) element.” In some embodiments, the optical element 188 includes an expended beam lens. In some embodiments, the optical element includes a reflector, a mirror, or a prism. The fiber alignment structure 183 may include a groove or an array of grooves having any suitable shape, including, for example, a V-shaped groove, a U-shaped groove, a trapezoidal-shaped groove, or a semicircular-shaped groove. The optical element 188 may include a single optical element or, as shown in FIGS. 5 and 7, may include an array of optical elements 188, including six or more than six, such as eight, twelve, twenty-four, or more than twenty-four. The number of optical elements 188 may be determined based on the number of channels of PIC 104. For example, in some embodiments, a photonic package 100 may require twelve channels for each PIC 104. In some embodiments, an array of twelve optical elements 188 may have a pitch of 250 microns. In some embodiments, an optical element 188 may include an expanded beam lens. In some embodiments, the connector 189 may be connected to either single mode (SM) or polarized mode (PM) fiber. The connector 189 may be an on-package connector that is physically connected to a component (e.g., a heat transfer structure 156, as shown in FIG. 1A) of the photonic package 100. The connector 189 may be physically connected to a component of the photonic package 100 using any suitable technique, including an adhesive material (e.g., an epoxy or film adhesive, a die attach film (DAF), or a B-stage underfill), or a mechanical means (e.g., a fastener or a clamp). The connector 189 may further include a connector alignment feature 181 and a fastener (e.g., fastener 117 in FIG. 6B) for coupling to an off-package connector (e.g., connector 289 of off-package FAU 103, as shown in FIG. 2A) to form an optical pathway between PIC 104 and an external optical source, as described below in greater detail with reference to FIGS. 2 and FIGS. 5-8.

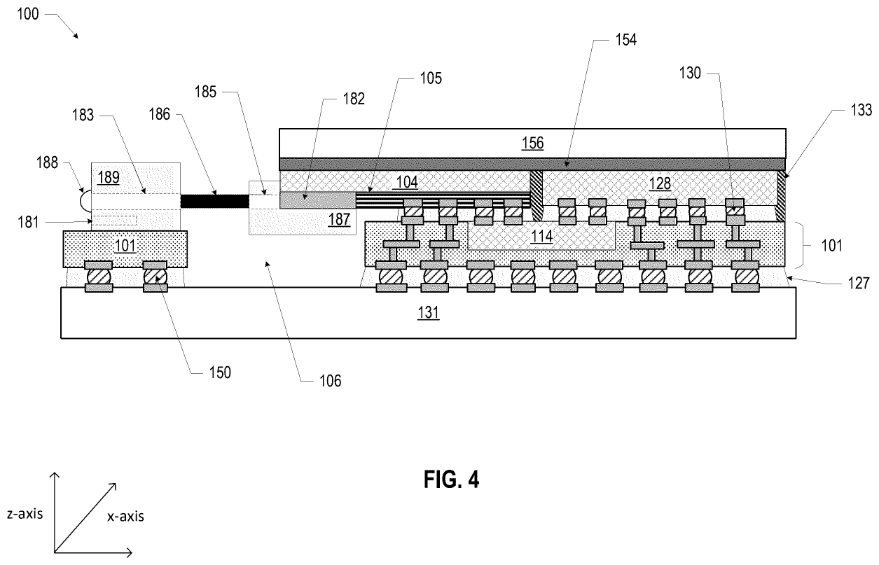

PIC 104 may include a first surface 171-1 (e.g., a bottom surface) and an opposing second surface 171-2 (e.g., a top surface), where the first surface 171-1 is also an active surface 105. A first portion of PIC 104 may extend beyond an edge of the substrate 101 and a second portion of PIC 104 may be within a footprint of the substrate 101. The first portion of the first surface 171-1 of PIC 104 may include a fiber alignment region 182 and the second portion of the first surface 171-1 of PIC 104 may include conductive contacts 122. The conductive contacts 122 may be electrically and mechanically coupled to conductive contacts 174 on the top surface of a substrate 101 and to conductive contacts 124 on a top surface of EIC 114 by interconnects 130. A first portion of active surface 105 of PIC 104 may include optical elements. Example optical elements over the first portion of active surface 105 are shown in more detail in FIG. 1B and described below. In some embodiments, an edge of the substrate 101 may include a cutout (e.g., cutout 107, as shown in FIG. 2B). In some embodiments, an edge of the substrate 101 may include an aperture (e.g., aperture 106, as shown in FIG. 4) in the substrate 101.

The fiber alignment region 182 of PIC 104 may include a groove for mounting a fiber therein and optically aligning with an optical element in PIC 104. The groove in the fiber alignment region 182 may have any suitable shape, such as a V-shaped groove. The fiber alignment region 182 may include a single groove or may include an array of grooves, including six or more than six, such as eight, twelve, or twenty-four.

An on-package FAU 102 may include a single fiber 186 or, as shown in FIG. 2B, may include an array of fibers 186. An array of fibers 186 may include any suitable number of fibers, including six or more than six, such as eight, twelve, or twenty-four. A fiber 186 may be secured to the fiber alignment region 182 of PIC 104 and/or the fiber alignment structure 183 of the connector 189 using any suitable technique, including an adhesive material, or other similar material such as a resin. In some embodiments, a fiber 186 may not be secured to the fiber alignment region 182 of PIC 104 and/or the fiber alignment structure 183 of the connector 189 rather the fiber 186 may simply rest or set within therein without being physically attached or coupled. The ends of the fiber 186 (e.g., at the connector 189 and/or at PIC 104) may be terminated using laser cleaving, which is a less labor-intensive and less-costly process than the usual process of fiber tip polishing in angled physical contact (APC).

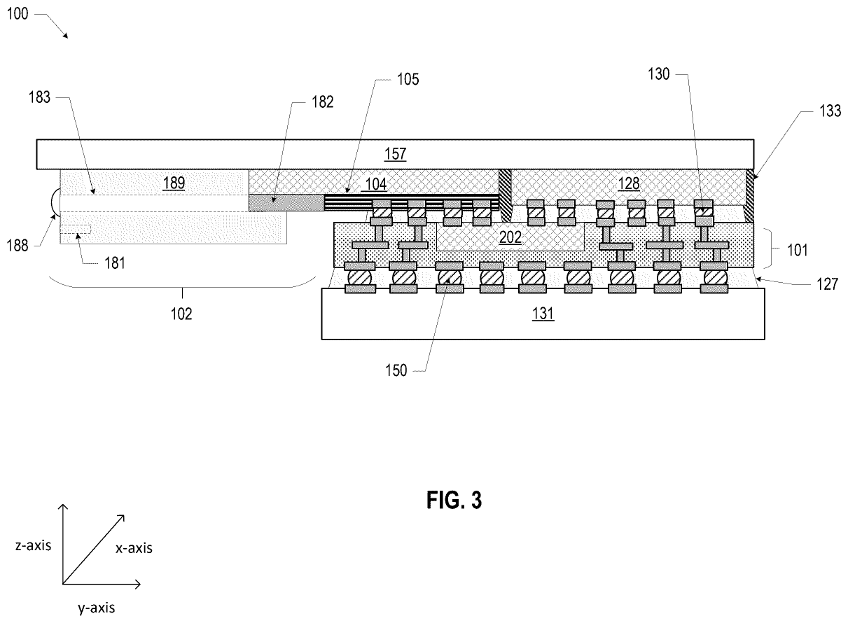

An on-package FAU 102 may further include a fiber connector 187 having a fiber alignment structure 185 to further assist with positioning and securing a fiber 186 such that a first end of the fiber 186 is optically aligned to an optical element in PIC 104 and an opposing second end of the fiber 186 is positioned to align with a fiber alignment structure 183 in the connector 189. In some embodiments, an on-package FAU 102 may not include a fiber connector 187, as shown in FIG. 3.

FIG. 1B is a schematic illustration of an example detail of an active surface of a photonic integrated circuit according to some embodiments of the present disclosure. PIC 104 may include functionality to convert an optical signal to an electrical signal and/or to convert an electrical signal to an optical signal. FIG. 1B is a schematic of optical elements at a face of active surface 105 (e.g., the first portion of the first surface 171-1) of PIC 104. Example optical elements include an electromagnetic radiation source 166, an electro-optical device 168, and a waveguide 164. In many embodiments, the optical elements may be fabricated on active surface 105 using any known method in the art, including semiconductor photolithographic and deposition methods. In some embodiments, the optical elements may extend substantially across an entire area of active surface 105 (not shown). In some embodiments, the optical elements may be confined within a portion of active surface 105. In some embodiments, a PIC 104 may be configured to transmit and/or receive an optical signal at a lateral surface, as shown in FIG. 1A. In such examples, PIC 104 may include optical elements, such as an edge coupler, a V-shaped groove array, or an angled reflector with a grating coupler, at an active surface 105 that allow PIC 104 to transmit and/or receive light through a lateral surface that is substantially perpendicular to the active surface 105 (e.g., lateral transmission and reception of light). In some embodiments, a PIC 104 may be configured to transmit and/or receive an optical signal at an active surface 105. For example, PIC 104 may include optical elements, such as a grating coupler, at an active surface 105 that allow PIC 104 to transmit and/or receive light through the active surface 105 (e.g., vertical transmission and reception of light).

Electromagnetic radiation source 166 can enable generating optical signals and may include lasers, for example if PIC 104 supports wavelengths between about 0.8 and 1.7 micrometer. Electro-optical device 168 can enable receiving, transforming, and transmitting optical signals. In some embodiments, electro-optical device 168 may be any device or component configured to encode information in/onto the electromagnetic signals, such as modulator, polarizer, phase shifter, and photodetector.

Waveguide 164 can guide optical signals and also perform coupling, switching, splitting, multiplexing and demultiplexing optical signals. In some embodiments, waveguide 164 may include any component configured to feed, or launch, the electromagnetic signal into the medium of propagation such as an optical fiber. In some embodiments, waveguide 164 may further be configured as optical multiplexers and/or demultiplexers, for example, to perform wavelength division multiplexing (WDM). In some embodiments, waveguide 164 may include a de-multiplexer, such as Arrayed Waveguide Grating (AWG) de-multiplexer, an Echelle grating, a single-mode waveguide, or a thin film filter (TFF) de-multiplexer. Waveguide 164 may comprise planar and non-planar waveguides of any type. In one example, waveguide 164 may comprise a silicon photonic waveguide based on silicon-on-isolator (SOI) platform, configured to guide electromagnetic radiation of any wavelength bands from about 0.8 micrometer to about 5.0 micrometer. In another example, waveguide 164 may support wavelengths from about 1.2 micrometer to about 1.7 micrometer in the near infrared and infrared bands for use in data communications and telecommunications.

Although only three such example optical elements are illustrated in FIG. 1B, it may be understood that PIC 104 may include more optical elements of the same or different types that enable it to function appropriately as a photonic device receiving, transforming, and transmitting optical and electrical signals.

In general, the light provided to PIC 104 may include any electromagnetic signals having information encoded therein (or, phrased differently, any electromagnetic signals modulated to include information). Often times, the electromagnetic signals are signals associated with optical amplitudes, phases, and wavelengths and, therefore, descriptions provided herein refer to “optical” signals (or light) and “optical” components. However, photonic package 100 with PIC 104, as described herein, are not limited to operating with electromagnetic signals of optical spectrum and descriptions provided herein with reference to optical signals and/or optical elements are equally applicable to electromagnetic signals of any suitable wavelength, such as electromagnetic signals in near-infrared (NIR) and/or infrared (IR) bands, as well as electromagnetic signals in the RF and/or microwave bands.

PIC 104 may comprise a semiconductor material including, for example, N-type or P-type materials. PIC 104 may include, for example, a crystalline substrate formed using a bulk silicon (or other bulk semiconductor material) or a SOI structure (or, in general, a semiconductor-on-insulator structure). In some embodiments, PIC 104 may be formed using alternative materials, which may or may not be combined with silicon, that include, but are not limited to, lithium niobite, indium phosphide, silicon dioxide, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group Ill-N or group IV materials. In some embodiments, PIC 104 may comprise a non-crystalline material, such as polymers. In some embodiments, PIC 104 may be formed on a printed circuit board (PCB). In some embodiments, PIC 104 may be inhomogeneous, including a carrier material (such as glass or silicon carbide) as a substrate with a thin semiconductor layer over which is active surface 105. Although a few examples of the material for PIC 104 are described here, any material or structure that may serve as a foundation upon which PIC 104 may be built falls within the spirit and scope of the present disclosure.

Returning to FIG. 1A, a photonic package 100 may further include EIC 114 and XPU 128. EIC 114 may be at least partially nested in a cavity in a dielectric material of a substrate 101. The substrate 101 may include conductive pathways 196 (e.g., including conductive traces and/or conductive vias, as shown) through a dielectric material. The substrate 101 may include a set of first conductive contacts 172 on the bottom surface of the substrate 101 and a set of second conductive contacts 174 on the top surface of the substrate 101, where the conductive pathways 196 electrically couple individual ones of the first and second conductive contacts 172, 174. The substrate 101 may be manufactured using any suitable technique, such as an additive technique (e.g., a semi-additive plating process (SAP) technique), a subtractive technique, or a redistribution layer technique. In some embodiments, a dielectric material of the substrate 101 may include an oxide material, such as silicon and oxygen (e.g., in the form of silicon oxide), a nitride material, such as or silicon and nitrogen (e.g., in the form of silicon nitride), or an organic material.

EIC 114 may be electrically coupled to PIC 104 and XPU 128 by interconnects 130. Interconnects 130 may enable electrical coupling between PIC 104, EIC 114, and XPU 128. Interconnects 130 disclosed herein may take any suitable form, including solder balls for a ball grid array arrangement, pins in a pin grid array arrangement or lands in a land grid array arrangement. In some embodiments, a set of interconnects 130 may include solder 132 (e.g., solder bumps or balls that are subject to a thermal reflow to form the interconnects 130). Interconnects 130 that include solder may include any appropriate solder material, such as lead/tin, tin/bismuth, eutectic tin/silver, ternary tin/silver/copper, eutectic tin/copper, tin/nickel/copper, tin/bismuth/copper, tin/indium/copper, tin/zinc/indium/bismuth, or other alloys. In some embodiments, a set of interconnects 130 may include an anisotropic conductive material, such as an anisotropic conductive film or an anisotropic conductive paste. An anisotropic conductive material may include conductive materials dispersed in a non-conductive material. In some embodiments, an anisotropic conductive material may include microscopic conductive particles embedded in a binder or a thermoset adhesive film (e.g., a thermoset biphenyl-type epoxy resin, or an acrylic-based material). In some embodiments, the conductive particles may include a polymer and/or one or more metals (e.g., nickel or gold). For example, the conductive particles may include nickel-coated gold or silver-coated copper that is in turn coated with a polymer. In another example, the conductive particles may include nickel. When an anisotropic conductive material is uncompressed, there may be no conductive pathway from one side of the material to the other.

However, when the anisotropic conductive material is adequately compressed (e.g., by conductive contacts on either side of the anisotropic conductive material), the conductive materials near the region of compression may contact each other so as to form a conductive pathway from one side of the film to the other in the region of compression. In some embodiments, interconnects 130 disclosed herein may have a pitch between about 2 microns and 150 microns (for example, between 2 microns and 10 microns, between 20 microns and 75 microns, or between 75 microns and 150 microns). Although FIG. 1A illustrates interconnects 130 as solder interconnects, interconnects 130 may include any suitable interconnects, for example, metal-to-metal bonds, or hybrid bonds.

The photonic package 100 of FIG. 1A may also include an underfill material 127. In some embodiments, the underfill material 127 may extend between PIC 104 and XPU 128 and the substrate 101 around the associated interconnects 130. An underfill material 127 may be disposed around interconnects 130 and interconnects 150. The underfill material 127 may be an insulating material, such as an appropriate epoxy material. In some embodiments, the underfill material 127 may include a capillary underfill, non-conductive film (NCF), or molded underfill. In some embodiments, the underfill material 127 may include an epoxy flux that assists with soldering PIC 104 and XPU 128 to EIC 114 when forming the interconnects 130, and then polymerizes and encapsulates the interconnects 130. The underfill process may include dispensing underfill material in liquid form, allowing the material to flow and fill the space between the interstitial gaps around interconnects 130, and subjecting the assembly to a curing process, such as baking, to solidify the material. In some embodiments, an underfill material 127 may be omitted. Although FIG. 1A shows two separate underfill 127 portions under PIC 104 and XPU 128, the underfill 127 may be a single underfill 127 under PIC 104 and XPU 128. The underfill material 127 may be selected to have a coefficient of thermal expansion (CTE) that may mitigate or minimize the stress between PIC 104, EIC 114, XPU 128, substrate 101, and circuit board 131 arising from uneven thermal expansion in the photonic package 100. In some embodiments, the CTE of the underfill material 127 may have a value that is intermediate to the CTE of the substrate 101 (e.g., the CTE of the dielectric material of the substrate 101) and a CTE of the insulating material of PIC 104, EIC 114, and/or XPU 128.

EIC 114 may include an IC configured to electrically integrate with PIC 104 to achieve an intended functionality of photonic package 100. For example, EIC 114 may be an Application Specific IC (ASIC), including one or more switch or driver/receiver circuits used in optical communication systems. In some embodiments, EIC 114 may include circuitry for communicating between two or more IC dies, for example, EIC 114 may function as an embedded multi-die interconnect bridge having appropriate circuitry on/in a semiconductor substrate to connect at silicon-interconnect speeds with a small footprint as part of an Omni-Directional Interface (ODI) architecture, for example, of 2.5D packages. In some embodiments, EIC 114 may comprise active components, including one or more transistors, voltage converters, trans-impedance amplifiers (TIA), serializer and de-serializer (SERDES), clock and data recovery (CDR) components, microcontrollers, etc. In some embodiments, EIC 114 may comprise passive circuitry sufficient to enable interconnection to PIC 104 and other components in photonic package 100 without any active components. In some embodiments, EIC 114 may extend under a substantial area of PIC 104. In various embodiments, EIC 114 and PIC 104 may overlap sufficiently to enable disposing interconnects 130 with a desired pitch and number of interconnections that enable photonic package 100 to function appropriately.

XPU 128 may include any suitable integrated chip with processing functionality, such as Central Processing Unit (CPU), Graphics Processing Unit (GPU), Field-Programmable Gate Array (FPGA), ASIC, and accelerator. In various embodiments, XPU 128 may be, or include, one or more voltage converters, Trans Impedance Amplifier (TIA), Clock and Data Recovery (CDR) components, microcontrollers, etc. Although FIG. 1A shows XPU 128 and EIC 114 as separate ICs, in some embodiments, XPU 128 may include EIC functionality, such that a photonic package 100 may include XPU 128 and may not include a separate EIC 114. In such embodiments, a bridge die, such as the bridge die 202 of FIG. 3, may replace EIC 114. Although FIG. 1A shows XPU 128 as a single IC, in some embodiments, XPU 128 may include multiple ICs coupled by interconnects 130.

The photonic package 100 of FIG. 1A may further include an insulating material 133 around and between PIC 104 and XPU 128. The insulating material 133 may include a material formed in multiple layers. In some embodiments, the insulating material 133 may be a dielectric material, such as an organic dielectric material, a fire retardant grade 4 material (FR-4), bismaleimide triazine (BT) resin, polyimide materials, glass reinforced epoxy matrix materials, or low-k and ultra low-k dielectric (e.g., carbon-doped dielectrics, fluorine-doped dielectrics, porous dielectrics, and organic polymeric dielectrics). In some embodiments, the insulating material 133 may be a mold material, such as an organic polymer with inorganic silica particles.

The photonic package 100 of FIG. 1A may also include a circuit board 131. In particular, conductive contacts 172 on a bottom surface of the substrate 101 may be electrically coupled to conductive contacts 146 on a top surface of circuit board 131 by interconnects 150. Interconnects 150 disclosed herein may take any suitable form, including any of the forms described above with reference to interconnects 130. As shown in FIG. 1A, in some embodiments, a set of interconnects 150 may include solder 136 (e.g., solder bumps or balls that are subject to a thermal reflow to form the interconnects 150). In some embodiments, the interconnects 150 disclosed herein may have a pitch between about 50 microns and 300 microns. In some embodiments, an underfill material 127 may extend between the substrate 101 and the circuit board 131 around the associated interconnects 150. The circuit board 131 may be a motherboard, for example, and may have other components attached to it. The circuit board may include conductive pathways and other conductive contacts for routing power, ground, and signals through the circuit board, as known in the art. In some embodiments, the interconnects 150 may not couple to a circuit board 131, but may instead couple to another IC package, an interposer, or any other suitable component.

The photonic package 100 of FIG. 1A may also include a TIM 154. The TIM 154 may include a thermally conductive material (e.g., metal particles) in a polymer or other binder. The TIM 154 may be a thermal interface material paste or a thermally conductive epoxy (which may be a fluid when applied and may harden upon curing, as known in the art). The TIM 154 may provide a path for heat generated by the dies (e.g., one or more of EIC 114, XPU 128, and PIC 104) to readily flow to a heat transfer structure 156, where it may be spread and/or dissipated. Some embodiments of the photonic package 100 of FIG. 1A may include a sputtered metallization (not shown) across the top surface of the XPU 128 and PIC 104, as well as on top of the insulating material 133; the TIM 154 (e.g., a solder TIM) may be disposed on this metallization.

The photonic package 100 of FIG. 1A may also include a heat transfer structure 156. The heat transfer structure 156 may be used to move heat away from one or more of the dies (e.g., one or more of EIC 114, XPU 128, and PIC 104), so that the heat may be more readily dissipated. The heat transfer structure 156 may include any suitable thermally conductive material (e.g., metal, appropriate ceramics, etc.), and may include any suitable features (e.g., a heat spreader, a heat sink including fins, a cold plate, etc.). In some embodiments, a heat transfer structure 156 may be or may include an integrated heat spreader (IHS). As shown in FIG. 1A, a heat transfer structure 156 may extend beyond the edge of the substrate 101 and the on-package connector 189 may be attached to the heat transfer structure 156, as described above.

In some embodiments, one or more levels of solder resist (e.g., epoxy liquid, liquid photoimageable polymers, dry film photoimageable polymers, acrylics, solvents) may be provided in an IC package described herein and may not be labeled or shown to avoid cluttering the drawings. Solder resist may be a liquid or dry film material including photoimageable polymers. In some embodiments, solder resist may be non-photoimageable.

Although FIG. 1A shows the photonic package 100 having a single PIC 104, a single EIC 114, a single XPU 128, a single fiber alignment region 182, and a single fiber connector 187, a photonic package 100 may have any suitable number and arrangement of PICs 104, EICs 114, XPUs 128, fiber alignment regions 182, and fiber connectors 187, and any suitable number and arrangement electrical and optical connections therebetween. Many of the elements of the photonic package 100 of FIG. 1 are included in other ones of the accompanying drawings; the discussion of these elements is not repeated when discussing these drawings, and any of these elements may take any of the forms disclosed herein. A number of elements are illustrated in FIG. 1 as included in the photonic package 100 may not be illustrated in other ones of the accompanying drawings but may be included in the photonic package 100. Further, a number of elements are illustrated in FIG. 1 as included in the photonic package 100, but a number of these elements may not be present in a photonic package 100. For example, in various embodiments, the TIM 154, the heat transfer structure 156, the insulating material 133, the underfill material 127, and the circuit board 131 may not be included. In some embodiments, individual ones of the photonic packages 100 disclosed herein may serve as a system-in-package (SiP) in which multiple dies having different functionality are included. In such embodiments, the photonic package 100 may be referred to as an SiP.

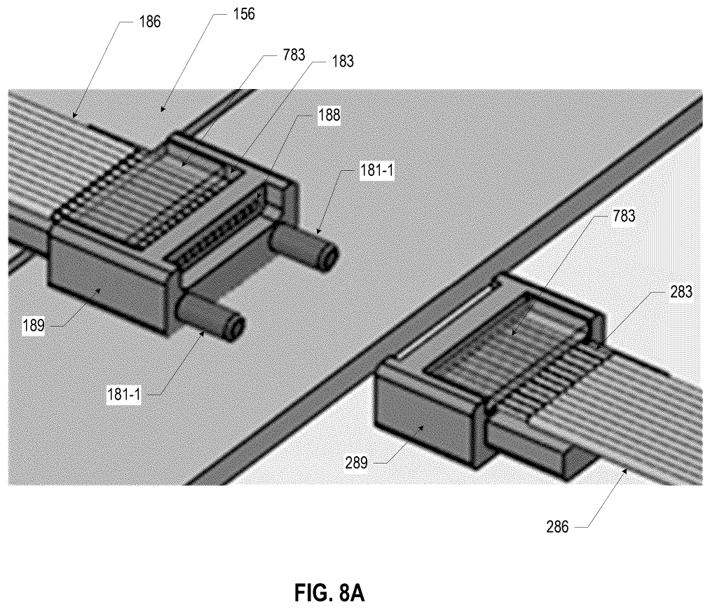

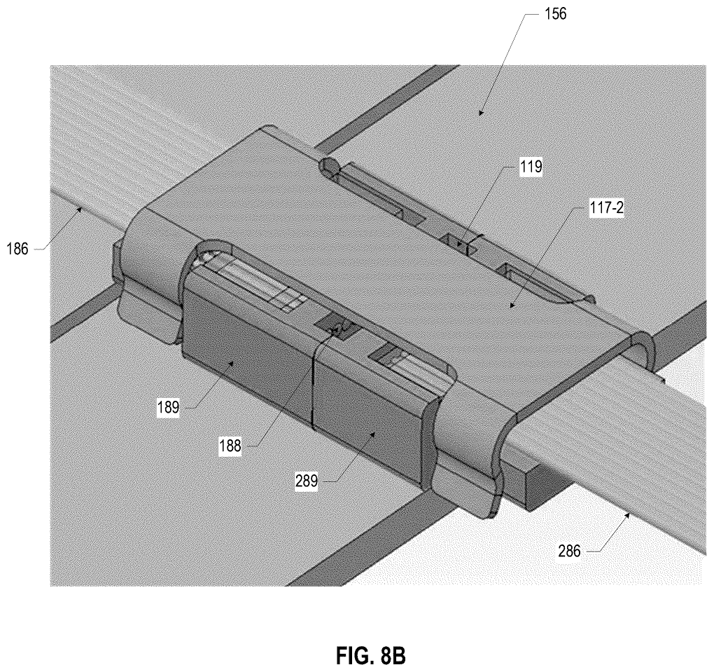

FIG. 2A is a schematic cross-sectional view of another example photonic package according to some embodiments of the present disclosure. The configuration of the embodiment shown in FIG. 2A is like that of FIG. 1A, except for differences as described further. The configuration of photonic package 100 as described herein omits the circuit board 131, interconnects 150, and underfill 127 around interconnects 150 to declutter the figure, and further includes an off-package FAU 103. The off-package FAU 103 includes a connector 289 having a fiber alignment structure 283 to optically align a first end of a fiber 286 to an optical element 288 at a lateral surface of the connector 289, where the optical element 288 is to expand and collimate an optical beam. An opposing second end of the fiber 286 in the off-package FAU 103 may be optically coupled to and may terminate in an external optical source connector 287, such as an MT ferrule. The fiber alignment structure 283 may include a groove or an array of grooves having any suitable shape, including, for example, a V-shaped groove, a semi-circular groove, or a U-shaped groove. The optical element 288 may include a single optical element or may include an array of optical elements 288, including six or more than six, as described above with reference to FIG. 1A. In some embodiments, an optical element 288 may include an expanded beam lens. The connector 289 may be an off-package connector that is physically connected (e.g., by a connector alignment feature 181 and/or a fastener, such as fastener 117 in FIGS. 6B and 8B) to an on-package connector 189 of the photonic package 100. The connector 289 and the connector 189, when coupled, may have an air gap 119 between the optical element 288 and the optical element 188. In some embodiments, the connector alignment feature 181 and/or a shape of the connector 289 and/or the connector 189 may function as a hard stop in order to maintain clearance between the optical element 288 and the optical element 188. The optical element 288 of the connector 289 may be optically aligned to the optical element 188 of the connector 189 by connector alignment feature 181 to form an optical pathway between PIC 104 and an external optical source.

FIG. 2B is a schematic perspective view of the example IC package of FIG. 2A according to some embodiments of the present disclosure. The configuration of the embodiment shown in FIG. 2B is the photonic package 100 of FIG. 2A that has been inverted so that the substrate 101 is at a top surface and the heat transfer structure 156 is at a bottom surface. The configuration of photonic package 100 as shown in FIG. 2B includes a substrate 101 having a cutout 107, a PIC 104 coupled to the substrate 101 with a first portion of PIC 104 including a fiber alignment region 182 extending beyond an edge of the substrate 101, an on-package FAU 102, and an off-package FAU 103. The on-package FAU 102 may include a fiber connector 187 with a fiber alignment structure 185, a connector 189 with a fiber alignment structure 183 and an array of optical elements 188 at a lateral surface, and an array of fibers 186, where individual fibers of the array of fibers 186 have a first end and an opposing second end, and the first ends of the individual fibers of the array of fibers 186 are optically coupled to the optical element in PIC 104 and the second ends of the individual fibers of the array of fibers 186 are optically coupled to individual optical elements of the array of optical elements 188 in the connector 189. The off-package FAU 103 may include a fiber connector 289 with a fiber alignment structure 283 and an array of optical elements 288 at a lateral surface, and an array of fibers 286, where individual fibers of the array of fibers 286 have a first end and an opposing second end, and the first ends of the individual fibers of the array of fibers 286 are optically coupled to individual optical elements of the array of optical elements 288 in the connector 289 and the second ends of the individual fibers of the array of fibers 286 are optically coupled to and terminate in an external optical source connector 287.

FIG. 3 is a schematic cross-sectional view of another example photonic package according to some embodiments of the present disclosure. The configuration of the embodiment shown in FIG. 3 is like that of FIG. 1A, except for differences as described further. The configuration of photonic package 100 as described herein does not include a fiber connector 187 and instead a connector 189 includes a fiber alignment structure 183 that optically couples a first end of a fiber (e.g., the fiber 186 in FIG. 1A) to a fiber alignment region 182 in PIC 104 and an opposing second end of the fiber to the optical element 188 at a lateral surface of the connector 189. The configuration of photonic package 100 shown in FIG. 3 further does not include EIC 114 and further includes PIC 104 and XPU 128 electrically coupled to bridge die 202. A bridge die 202 may be at least partially nested in a dielectric material of the substrate 101 (e.g., partially surrounded by or embedded in a dielectric material of the substrate 101). A bridge die 202 may comprise appropriate circuitry on/in a semiconductor substrate to connect at silicon-interconnect speeds with a small footprint. In some embodiments, bridge die 202 may comprise active components, such as transistors and diodes in addition to bridge circuitry including metallization traces, vias and passive components for enabling electrical coupling between two ICs; in other embodiments, bridge die 202 may include bridge circuitry including metallization traces, vias and passive components for enabling electrical coupling between PIC 104 and XPU 128, and may not include active components. The configuration of photonic package 100 shown in FIG. 3 further does not include a TIM 154 or a heat transfer structure 156 and instead includes a stiffener 157, where the connector 189 is physically coupled to the stiffener 157. A stiffener 157 may be made from any suitable material that provides mechanical stability to the photonic package 100, including a conductive material, such as a metal (e.g., copper or aluminum), or a non-conductive material, such as, ceramic, ceramic and metal, or silicon carbide and diamond, and made using any suitable technique, such as molding or sintering. The connector 189 may be physically coupled to the stiffener 157 using any suitable technique, including an adhesive material or a mechanical means, as described above with reference to FIG. 1A. The stiffener 157 may have any suitable thickness (e.g., z-dimension). The thickness of the stiffener may depend on the type of material or materials used to mitigate warpage, and may further depend on the size of the stiffener 157. For example, a stiffener 157 having larger xy-dimensions (e.g., length and/or width) may have a greater thickness and/or be made of more rigid material. In some embodiments, the stiffener 157 may have a protective layer or other layer deposited on the top surface to, for example, facilitate thermal dissipation.

FIG. 4 is a schematic cross-sectional view of yet another example photonic package according to some embodiments of the present disclosure. The configuration of the embodiment shown in FIG. 4 is like that of FIG. 1A, except for differences as described further. The configuration of photonic package 100 as described herein includes a substrate 101 having an aperture 106, where a PIC 104 is at an inner edge of the substrate 101 and a connector 189 is physically coupled to an outer edge or perimeter of the substrate 101. The connector 189 may be physically coupled to the substrate 101 using any suitable technique, including an adhesive.

FIG. 5A is a perspective view of an example expanded beam connector according to some embodiments of the present disclosure. As shown in FIG. 5A, a connector 189 may include a fiber alignment structure 183, an array of optical elements 188, and a connector alignment feature 181. The fiber alignment structure 183 may include an array of grooves having any suitable size and shape, as described above with reference to FIG. 1A. The array of optical elements 188 may include an array of expanded beam lenses. The connector alignment feature 181 may include a post 181-1 and a socket 181-2 for aligning and coupling to a connector 289 (e.g., as shown in FIG. 6A). The connector 189 may further include connector alignment features 181-3, 181-4 for aligning and coupling the array of optical elements 188 to the connector 189. The connector 189 may include a recess and the array of optical elements 188 may be attached within the recess so that when the connector 189 is coupled to a connector 289, there is a space (e.g., air gap 119, as shown in FIG. 2A) between the optical elements 188, 288. The connector 289 may have a same structure as the connector 189 (e.g., a fiber alignment structure 283 is a same structure as a fiber alignment structure 183 and an array of optical elements 288 is a same structure as an array of optical elements 188). A post 181-1 may be formed as a separate part (e.g., as described below with reference to FIG. 5B), such that the position of the post 181-1 may be swapped, or a connector 189 may include two posts 181-1 and the mated connector 289 may include two sockets 181-2, or vice versa, so that the connector 189 and the connector 289 form a mated pair. The connector 189 may have any suitable dimensions. For example, for a 12-channel or 24-channel connector, the connector 189 may have a length 191 (e.g., x-dimension) between 5 millimeters and 10 millimeters, a width 193 (e.g., y-dimension) between 3 millimeters and 8 millimeters, and a thickness 195 (e.g., z-dimension) between 0.5 millimeters and 2 millimeters. The dimensions of the connector 189 may change (e.g., may be scaled up or down accordingly) with an increasing number or a decreasing number of fiber channels of PIC 104.

The connector 189 in FIG. 5A, and the connector 289, may be formed using a 3-dimensional (3D) printing process. The connector 189, 289 may be formed using any suitable material, including a 3D printing optical polymer, a 3D optical resin, or a 3D printing grade glass. An 3D printing optical polymer or optical resin may include a high temperature resistant optical polymer or resin having a degradation temperature between 200 degrees Celsius and 300 degrees Celsius for high temperature solder reflow technology. For example, a high temperature resistant optical polymer or resin may undergo multiple solder reflow cycles of up to 260 degrees Celsius without the material deforming, causing the optical elements 188, 288 to misalign from the finer alignment structure 183, 283, and/or causing the connector alignment feature 181 to deform or misalign. A 3D printing optical polymer or resin may further include optical polymers or resins having a degradation temperature between 135 degrees Celsius and 200 degrees Celsius for low-temperature solder reflow technology, where the optical grade polymer may undergo multiple solder reflow cycles of up to 190 degrees Celsius without the material deforming or misaligning, as described above. The array of optical elements 188 may include any suitable optical grade 3D printing material.

FIG. 5B is an expanded perspective view of the example expanded beam connector of FIG. 5A according to some embodiments of the present disclosure. FIG. 5B illustrates that the example expanded beam connector of FIG. 5A may be 3D printed in three parts, a first part including the connector 189, the fiber alignment structure 183, and the connector alignment features 181-2 (i.e., a socket), 181-3, 181-4, a second part including the connector alignment feature 181-1 (i.e., a post), and a third part including the array of optical elements 188. For example, the first part and second part may be 3D printed using micro-level lithography having a precision between 1 micron and 2 microns, and the third part may be 3D printed using nano-to-submicron resolution technology, such as two-photon polymerization (2PP). The array of optical elements 188 may have any suitable dimensions and, in some embodiments, a y-dimension 197 of the array of optical elements 188 is between 150 microns and 400 microns. The first part and second part may be assembled and may be physically attached using any suitable technique, including an adhesive. The third part (e.g., the array of optical components 188) may be assembled and may be physically attached using any suitable technique, such as an optical adhesive.

FIG. 5C is a schematic front view of the expanded beam connector of FIG. 5A according to some embodiments of the present disclosure. FIG. 5C shows a connector 189 from a front view including optical elements 188 and connector alignment features 181-1 (e.g., a post), 181-2 (e.g., a socket), 181-3, 181-4. FIG. 5C illustrates that the optical elements 188 may include an array of twelve expanded beam lenses.

FIG. 5D is a schematic front view of an example expanded beam connector according to some embodiments of the present disclosure. FIG. 5D shows a connector 189 from a front view including optical elements 188 and connector alignment features 181-1 (e.g., a post), 181-2 (e.g., a socket), 181-3, 181-4. FIG. 5D illustrates that the optical elements 188 may include a stack of two arrays of twelve expanded beam lenses. Although FIGS. 5C and 5D illustrate a particular number and arrangement of optical elements 188, a connector 189 may include any suitable number and arrangement of optical elements 188, as described above with reference to FIG. 1A.

FIG. 6A is a perspective view of some components of the example IC package of FIG. 2A and the example connectors of FIG. 5 prior to coupling according to some embodiments of the present disclosure. FIG. 6A illustrates a connector 189 is physically coupled to a heat transfer structure 156. The connector 189 includes fibers 186 mounted in a fiber alignment structure 183 and optically aligned with an array of optical elements 188, and connector alignment features 181-1, 181-2. FIG. 6A further illustrates a connector 289 including fibers 286 mounted in a fiber alignment structure 283 and optically aligned with an array of optical elements 288 (not shown), and connector alignment features 181-1, 181-2, where the connector alignment features 181-1, 181-2 of the connector 189 are aligned with the respective connector alignment features 181-2, 181-1 of the connector 289.

FIG. 6B is a perspective view of the components of FIG. 6A after coupling and attaching a fastener according to some embodiments of the present disclosure. FIG. 6B illustrates a connector 189 coupled to a connector 289 with a fastener 117-1 attached. The fastener 117-1 may include any suitable fastener, such as, as shown, a spring clip having grip portions attached at ends of the connectors 189, 289 adjacent to the respective fibers 186, 286. The coupled connectors 189, 289 form an optical pathway between fibers 186 and fibers 286.

FIGS. 7A and 7B are schematic perspective views of a pair of example expanded beam connectors according to some embodiments of the present disclosure. As shown in FIG. 7A, a connector 189 may include a fiber alignment structure 183, an array of optical elements 188, and two connector alignment features 181-1 (e.g., two posts). The fiber alignment structure 183 may include an array of grooves having any suitable size and shape, as described above with reference to FIG. 1A. In some embodiments, the connector 189 may further include a lid 783 to align and secure the fibers 186 in the fiber alignment structure 183. The array of optical elements 188 may include an array of expanded beam lenses. The connector 189 may include a recess and the array of optical elements 188 may be within the recess so that when the connector 189 is coupled to a connector 289, there is a space (e.g., air gap 119, as shown in FIG. 2A) between the optical elements 188, 288. As shown in FIG. 7B, a connector 289 may have a same structure as the connector 189 (e.g., a fiber alignment structure 283 is a same structure as a fiber alignment structure 183, an array of optical elements 288 is a same structure as an array of optical elements 188, and a lid 783), except that the connector alignment features 181-2 include sockets so that the connector 189 and the connector 289 form a mated pair. The connector 189 may have any suitable dimensions, for example, the connector 189 may have dimensions as described above with reference to FIG. 5A.

The connectors 189, 289 in FIGS. 7A and 7B may be a single unit (e.g., each connector is a unibody part) formed using an injection molding process, such as Glass Injection Molding (GIM) or Plastic Injection Molding (PIM) depending on a material of the connector 189, 289. The connector 189, 289 may be formed using any suitable material, including a fused silica glass, an optical grade polymer, or a combination thereof. An optical polymer may include a high temperature resistant optical grade polymer having a degradation temperature between 200 degrees Celsius and 300 degrees Celsius for high temperature solder reflow technology. For example, a high temperature resistant optical grade polymer may undergo multiple solder reflow cycles of up to 260 degrees Celsius without the material deforming, causing the optical elements 188, 288 to misalign from the finer alignment structure 183, 283, and/or causing the connector alignment feature 181 to deform or misalign. An optical grade polymer may further include optical grade polymers having a degradation temperature between 135 degrees Celsius and 200 degrees Celsius for low-temperature solder reflow technology, where the optical grade polymer may undergo multiple solder reflow cycles of up to 190 degrees Celsius without the material deforming or misaligning, as described above. The array of optical elements 188, 288 may be formed as part of the injection molding process such that the array of optical elements 188, 288 are not subsequently attached (e.g., as in the 3D printed embodiment of FIG. 5) and are designed to be optically aligned to the fiber alignment structure 183, 283.

FIG. 7C is a schematic front view of the expanded beam connector of FIG. 7A according to some embodiments of the present disclosure. FIG. 7C shows a connector 189 from a front view including optical elements 188 and connector alignment features 181-1 (e.g., two posts). FIG. 5C illustrates that the optical elements 188 may include an array of twelve expanded beam lenses.

FIG. 8A is a perspective view of some components of the example IC package of FIG. 2A and the example connectors of FIG. 7 according to some embodiments of the present disclosure. FIG. 8A illustrates a connector 189 is physically coupled to a heat transfer structure 156. The connector 189 includes fibers 186 mounted in a fiber alignment structure 183 having a lid 783 and optically aligned with an array of optical elements 188, and two connector alignment features 181-1. FIG. 8A further illustrates a connector 289 including fibers 286 mounted in a fiber alignment structure 283 having a lid 783 and optically aligned with an array of optical elements 288 (not shown). The connector 289 further includes two connector alignment features 181-2 (not shown), where the connector alignment features 181-1 of the connector 189 are aligned with the respective connector alignment features 181-2 of the connector 289.

FIG. 8B is a perspective view of the components of FIG. 8A after coupling and attaching a fastener according to some embodiments of the present disclosure. FIG. 8B illustrates a connector 189 coupled to a connector 289 with a fastener 117-2 attached. The fastener 117-2 may include any suitable fastener, such as, as shown, a spring clip having grip portions attached at sides of the connectors 189, 289 adjacent to the respective fibers 186, 286. The coupled connectors 189, 289 form an optical pathway between fibers 186 and fibers 286. FIG. 8B further shows an air gap 119 between the optical elements 188 and the optical elements 288 (not shown). Although FIGS. 8A and 8B illustrate the connector 189 as on-package and the connector 289 as off-package, the connectors are interchangeable such that the connector 289 may be on-package and the connector 189 may be off-package.

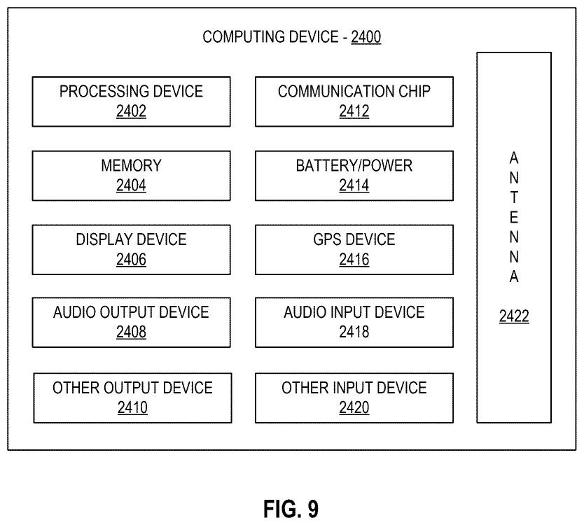

The photonic IC packages 100 disclosed herein may be included in any suitable electronic component. FIG. 9 is a block diagram of an example computing device 2400 that may include one or more components having one or more IC packages 100 in accordance with any of the embodiments disclosed herein. For example, any suitable ones of the components of computing device 2400 may include an IC package 100 in accordance with any of the embodiments disclosed herein. A number of components are illustrated in the figure as included in computing device 2400, but any one or more of these components may be omitted or duplicated, as suitable for the application. In some embodiments, some or all of the components included in computing device 2400 may be attached to one or more motherboards. In some embodiments, some or all of these components are fabricated onto a single SoC die.

Additionally, in various embodiments, computing device 2400 may not include one or more of the components illustrated in the figure, but computing device 2400 may include interface circuitry for coupling to the one or more components. For example, computing device 2400 may not include a display device 2406, but may include display device interface circuitry (e.g., a connector and driver circuitry) to which display device 2406 may be coupled. In another set of examples, computing device 2400 may not include an audio input device 2418 or an audio output device 2408, but may include audio input or output device interface circuitry (e.g., connectors and supporting circuitry) to which audio input device 2418 or audio output device 2408 may be coupled.

Computing device 2400 may include a processing device 2402 (e.g., one or more processing devices). As used herein, the term “processing device” or “processor” may refer to any device or portion of a device that processes electronic data from registers and/or memory to transform that electronic data into other electronic data that may be stored in registers and/or memory. Processing device 2402 may include one or more DSPs, ASICs, CPUs, GPUs, cryptoprocessors (specialized processors that execute cryptographic algorithms within hardware), server processors, or any other suitable processing devices. Computing device 2400 may include a memory 2404, which may itself include one or more memory devices such as volatile memory (e.g., dynamic random access memory (DRAM)), nonvolatile memory (e.g., read-only memory (ROM)), flash memory, solid-state memory, and/or a hard drive. In some embodiments, memory 2404 may include memory that shares a die with processing device 2402. This memory may be used as cache memory and may include embedded dynamic random access memory (eDRAM) or spin transfer torque magnetic random access memory (STT-MRAM).

In some embodiments, computing device 2400 may include a communication chip 2412 (e.g., one or more communication chips). For example, communication chip 2412 may be configured for managing wireless communications for the transfer of data to and from computing device 2400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

Communication chip 2412 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), LTE project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 2412 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 2412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication chip 2412 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication chip 2412 may operate in accordance with other wireless protocols in other embodiments. Computing device 2400 may include an antenna 2422 to facilitate wireless communications and/or to receive other wireless communications (such as AM or FM radio transmissions).

In some embodiments, communication chip 2412 may manage wired communications, such as electrical, optical, or any other suitable communication protocols (e.g., the Ethernet). As noted above, communication chip 2412 may include multiple communication chips. For instance, a first communication chip 2412 may be dedicated to shorter-range wireless communications such as Wi-Fi or Bluetooth, and a second communication chip 2412 may be dedicated to longer-range wireless communications such as global positioning system (GPS), EDGE, GPRS, CDMA, WiMAX, LTE, EV-DO, or others. In some embodiments, a first communication chip 2412 may be dedicated to wireless communications, and a second communication chip 2412 may be dedicated to wired communications.

Computing device 2400 may include battery/power circuitry 2414. Battery/power circuitry 2414 may include one or more energy storage devices (e.g., batteries or capacitors) and/or circuitry for coupling components of computing device 2400 to an energy source separate from computing device 2400 (e.g., AC line power).

Computing device 2400 may include a display device 2406 (or corresponding interface circuitry, as discussed above). Display device 2406 may include any visual indicators, such as a heads-up display, a computer monitor, a projector, a touchscreen display, a liquid crystal display (LCD), a light-emitting diode display, or a flat panel display, for example.

Computing device 2400 may include audio output device 2408 (or corresponding interface circuitry, as discussed above). Audio output device 2408 may include any device that generates an audible indicator, such as speakers, headsets, or earbuds, for example.

Computing device 2400 may include audio input device 2418 (or corresponding interface circuitry, as discussed above). Audio input device 2418 may include any device that generates a signal representative of a sound, such as microphones, microphone arrays, or digital instruments (e.g., instruments having a musical instrument digital interface (MIDI) output).

Computing device 2400 may include a GPS device 2416 (or corresponding interface circuitry, as discussed above). GPS device 2416 may be in communication with a satellite-based system and may receive a location of computing device 2400, as known in the art.

Computing device 2400 may include other output device 2410 (or corresponding interface circuitry, as discussed above). Examples of other output device 2410 may include an audio codec, a video codec, a printer, a wired or wireless transmitter for providing information to other devices, or an additional storage device.

Computing device 2400 may include other input device 2420 (or corresponding interface circuitry, as discussed above). Examples of other input device 2420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 2400 may have any desired form factor, such as a handheld or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, computing device 2400 may be any other electronic device that processes data.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

The following paragraphs provide various examples of the embodiments disclosed herein.

Example 1 is a photonic package, including a substrate including a dielectric material with conductive pathways; a photonic integrated circuit (PIC) having a first optical element, the PIC electrically coupled to the substrate; a connector including a fiber alignment structure; and a second optical element, wherein the second optical element is to expand and collimate an optical beam, and wherein a material of the connector includes a 3-dimensional (3D) printing optical polymer, a 3D printing grade glass, or a 3D printing optical resin; and a fiber having a first end and an opposing second end, wherein the fiber is positioned in the fiber alignment structure, and wherein the first end of the fiber is optically coupled to the first optical element and the second end of the fiber is optically coupled to the second optical element.

Example 2 may include the subject matter of Example 1, and may further specify that the second optical element includes an expanded beam lens.

Example 3 may include the subject matter of Example 1 or 2, and may further specify that the fiber alignment structure includes a groove.

Example 4 may include the subject matter of any of Examples 1-3, and may further specify that the connector has a length between 5 millimeters and 10 millimeters, a width between 3 millimeters and 8 millimeters, and a thickness between 0.5 millimeters and 2 millimeters.

Example 5 may include the subject matter of any of Examples 1-4, and may further specify that the connector is a three-part assembly.

Example 6 may include the subject matter of any of Examples 1-5, and may further specify that the fiber is one of a plurality of fibers, the second optical element is one of a plurality of second optical elements, and the fiber alignment structure includes a plurality of grooves.

Example 7 may include the subject matter of any of Examples 1-6, and may further specify that the connector is physically coupled to the substrate.

Example 8 may include the subject matter of any of Examples 1-6, and may further include a heat spreader, wherein the connector is physically coupled to the heat spreader.

Example 9 may include the subject matter of any of Examples 1-6, and may further include a stiffener, wherein the connector is physically coupled to the stiffener.

Example 10 may include the subject matter of any of Examples 1-9, and may further specify that the connector further includes a connector alignment feature.

Example 11 may include the subject matter of Example 10, and may further specify that the connector alignment feature includes a post and a socket, a first post and a second post, or a first socket and a second socket.

Example 12 may include the subject matter of Example 10, and may further specify that the connector is a first connector having a first fiber alignment structure and a first connector alignment feature, and the fiber is a first fiber, and the photonic package may further include a second connector including a second fiber alignment structure; a third optical element at a lateral surface of the second fiber alignment structure, wherein the third optical element is to expand and collimate an optical beam; and a second connector alignment feature, wherein the second connector is coupled to the first connector by the first and second connector alignment features with the third optical element facing the second optical element; and a second fiber having a first end and an opposing second end, wherein the second fiber is mounted in the second fiber alignment structure, and wherein the first end of the second fiber is optically coupled to the third optical element and the second end of the fiber is optically coupled to an external optical source connector.

Example 13 may include the subject matter of Example 12, and may further specify that the first connector and the second connector are further coupled by a fastener.

Example 14 may include the subject matter of Example 13, and may further specify that the fastener includes a spring clip.

Example 15 is a photonic package, including a substrate including a dielectric material with conductive pathways; a photonic integrated circuit (PIC) having a first optical element, the PIC electrically coupled to the substrate; a connector including a fiber alignment structure; and a second optical element, wherein the second optical element is to expand and collimate an optical beam, and wherein a material of the connector includes a fused silica glass, an optical grade polymer, or a combination thereof; and a fiber having a first end and an opposing second end, wherein the fiber is positioned in the fiber alignment structure, and wherein the first end of the fiber is optically coupled to the first optical element and the second end of the fiber is optically coupled to the second optical element.

Example 16 may include the subject matter of Example 15, and may further specify that the second optical element includes an expanded beam lens.

Example 17 may include the subject matter of Example 15 or 16, and may further specify that the connector has a length between 5 millimeters and 10 millimeters, a width between 3 millimeters and 8 millimeters, and a thickness between 0.5 millimeters and 2 millimeters.

Example 18 may include the subject matter of any of Examples 15-17, and may further specify that the connector is a unitary part.

Example 19 may include the subject matter of any of Examples 15-18, and may further specify that the fiber is one of a plurality of fibers, the second optical element is one of a plurality of second optical elements, and the fiber alignment structure includes a plurality of grooves.

Example 20 may include the subject matter of any of Examples 15-19, and may further specify that the connector is physically coupled to the substrate.

Example 21 may include the subject matter of any of Examples 15-19, and may further include a heat spreader, wherein the connector is physically coupled to the heat spreader.

Example 22 may include the subject matter of any of Examples 15-19, and may further include a stiffener, wherein the connector is physically coupled to the stiffener.

Example 23 may include the subject matter of any of Examples 15-22, and may further specify that the connector further includes a connector alignment feature.

Example 24 may include the subject matter of Example 23, and may further specify that the connector alignment feature includes a first post and a second post, or a first socket and a second socket.

Example 25 may include the subject matter of Example 23, and may further specify that the connector is a first connector having a first fiber alignment structure and a first connector alignment feature, and the fiber is a first fiber, and the photonic package may further include a second connector including a second fiber alignment structure; a third optical element at a lateral surface of the second fiber alignment structure, wherein the third optical element is to expand and collimate an optical beam; and a second connector alignment feature, wherein the second connector is coupled to the first connector by the first and second connector alignment features with the third optical element facing the second optical element; and a second fiber having a first end and an opposing second end, wherein the second fiber is mounted in the second fiber alignment structure, and wherein the first end of the second fiber is optically coupled to the third optical element and the second end of the fiber is optically coupled to an external optical source connector.

Example 26 may include the subject matter of Example 25, and may further specify that the first connector and the second connector are further coupled by a fastener.

Example 27 may include the subject matter of Example 26, and may further specify that the fastener includes a spring clip.

Example 28 is a photonic package, including a substrate including a dielectric material with conductive pathways; a photonic integrated circuit (PIC) including a first optical element, wherein the PIC is electrically coupled to one or more of the conductive pathways in the substrate; a fiber having a first end and an opposing second end; a first fiber alignment structure, wherein the fiber is positioned in the first fiber alignment structure and the first end of the fiber is optically coupled to the first optical element; and a connector including a second fiber alignment structure; and a second optical element, wherein the second optical element is to expand and collimate an optical beam, wherein the fiber is positioned in the second fiber alignment structure and the second end of the fiber is optically coupled to the second optical element, and wherein a material of the connector includes a fused silica glass, an optical grade polymer, or a combination thereof.

Example 29 may include the subject matter of Example 28, and may further specify that the second optical element includes an expanded beam lens.

Example 30 may include the subject matter of Example 28 or 29, and may further specify that the connector has a length between 5 millimeters and 10 millimeters, a width between 3 millimeters and 8 millimeters, and a thickness between 0.5 millimeters and 2 millimeters.

Example 31 may include the subject matter of any of Examples 28-30, and may further specify that the connector is a unitary part.

Example 32 may include the subject matter of any of Examples 28-31, and may further specify that the first fiber alignment structure and the connector are physically coupled to the substrate.

Example 33 may include the subject matter of any of Examples 28-31, and may further include a heat spreader, wherein the first fiber alignment structure and the connector are physically coupled to the heat spreader.

Example 34 may include the subject matter of any of Examples 28-31, and may further include a stiffener, wherein the first fiber alignment structure and the connector are physically coupled to the stiffener.

Example 35 may include the subject matter of any of Examples 28-34, and may further specify that the connector further includes a connector alignment feature.

Example 36 may include the subject matter of Example 35, and may further specify that the connector alignment feature includes a first post and a second post, or a first socket and a second socket.

Example 37 may include the subject matter of Example 35, and may further specify that the connector is a first connector having a first connector alignment feature and the fiber is a first fiber, and the photonic package may further include a second connector including a third fiber alignment structure; a third optical element, wherein the third optical element is to expand and collimate an optical beam; and a second connector alignment feature, wherein the second connector is coupled to the first connector by the first and second connector alignment features with the third optical element facing the second optical element; and a second fiber having a first end and an opposing second end, wherein the second fiber is mounted in the third fiber alignment structure, and wherein the first end of the second fiber is optically coupled to the third optical element and the second end of the fiber is optically coupled to an external optical source connector.

Example 38 may include the subject matter of Example 37, and may further specify that the first connector and the second connector are further coupled by a fastener.

Example 39 may include the subject matter of Example 38, and may further specify that the fastener includes a spring clip.

Example 40 is a photonic package, including a substrate having a surface with an edge, wherein the substrate includes a dielectric material with conductive pathways; a fiber having a first end and an opposing second end; a photonic integrated circuit (PIC) having a first surface and an opposing second surface, and including a first portion within a footprint of the substrate and a second portion that extends beyond the edge of the substrate, wherein the first surface of the first portion of the PIC is electrically coupled to one or more of the conductive pathways in the substrate, and the first surface of the second portion of the PIC includes a first optical element and a first fiber alignment structure, wherein the fiber is mounted in the first fiber alignment structure and the first end of the fiber is optically coupled to the first optical element; and a connector including a second fiber alignment structure; and a second optical element at a lateral surface of the second fiber alignment structure, wherein the second optical element is to expand and collimate an optical beam, wherein the fiber is mounted in the second fiber alignment structure, wherein the second end of the fiber is optically coupled to the second optical element, and wherein a material of the connector includes a 3-dimensional (3D) printing optical polymer, a 3D printing grade glass, or a 3D printing optical resin.

Example 41 may include the subject matter of Example 40, and may further specify that the second optical element includes an expanded beam lens.

Example 42 may include the subject matter of Example 40 or 41, and may further specify that the connector has a length between 5 millimeters and 10 millimeters, a width between 3 millimeters and 8 millimeters, and a thickness between 0.5 millimeters and 2 millimeters.

Example 43 may include the subject matter of any of Examples 40-42, and may further specify that the connector is a three-part assembly.

Example 44 may include the subject matter of any of Examples 40-43, and may further specify that the fiber is one of a plurality of fibers, the first optical element is one of a plurality of first optical elements, the second optical element is one of a plurality of second optical elements, the first fiber alignment structure includes a plurality of first grooves, and the second fiber alignment structure includes a plurality of second grooves.

Example 45 may include the subject matter of any of Examples 40-44, and may further specify that the connector is physically coupled to the surface of the substrate.

Example 46 may include the subject matter of any of Examples 40-44, and may further include a heat spreader, wherein the connector is physically coupled to the heat spreader.

Example 47 may include the subject matter of any of Examples 40-44, and may further include a stiffener, wherein the connector is physically coupled to the stiffener.

Example 48 may include the subject matter of any of Examples 40-47, and may further specify that the connector further includes a connector alignment feature.

Example 49 may include the subject matter of Example 48, and may further specify that the connector alignment feature includes a post and a socket, a first post and a second post, or a first socket and a second socket.

Example 50 may include the subject matter of Example 48, and may further specify that the connector is a first connector having a first connector alignment feature and the fiber is a first fiber, and the photonic package may further include a second connector including a third fiber alignment structure; a third optical element, wherein the third optical element is to expand and collimate an optical beam; and a second connector alignment feature, wherein the second connector is coupled to the first connector by the first and second connector alignment features with the third optical element facing the second optical element; and a second fiber having a first end and an opposing second end, wherein the second fiber is mounted in the third fiber alignment structure, and wherein the first end of the second fiber is optically coupled to the third optical element and the second end of the fiber is optically coupled to an external optical source connector.

Example 51 may include the subject matter of Example 50, and may further specify that the first connector and the second connector are further coupled by a fastener.

Example 52 may include the subject matter of Example 51, and may further specify that the fastener includes a spring clip.

1. A photonic package, comprising:
a substrate including a dielectric material with conductive pathways;
a photonic integrated circuit (PIC) having a first optical element, the PIC electrically coupled to the substrate;
a connector including:
a fiber alignment structure; and
a second optical element, wherein the second optical element includes an expanded beam lens, and wherein a material of the connector includes a 3-dimensional (3D) printing optical polymer, a 3D printing grade glass, or a 3D printing optical resin; and
a fiber having a first end and an opposing second end, wherein the fiber is positioned in the fiber alignment structure, and wherein the first end of the fiber is optically coupled to the first optical element and the second end of the fiber is optically coupled to the second optical element.

2. The photonic package of claim 1, wherein the connector has a length between 5 millimeters and 10 millimeters, a width between 3 millimeters and 8 millimeters, and a thickness between 0.5 millimeters and 2 millimeters.

3. The photonic package of claim 1, wherein the connector is a three-part assembly.

4. The photonic package of claim 1, wherein the connector further includes a connector alignment feature.

5. The photonic package of claim 4, wherein the connector alignment feature includes a post and a socket.

6. The photonic package of claim 4, wherein the connector is a first connector having a first fiber alignment structure and a first connector alignment feature, and the fiber is a first fiber, and the photonic package, further comprising:
a second connector including:
a second fiber alignment structure;
a third optical element at a lateral surface of the second fiber alignment structure, wherein the third optical element is to expand and collimate an optical beam; and
a second connector alignment feature, wherein the second connector is coupled to the first connector by the first and second connector alignment features with the third optical element facing the second optical element; and
a second fiber having a first end and an opposing second end, wherein the second fiber is mounted in the second fiber alignment structure, and wherein the first end of the second fiber is optically coupled to the third optical element and the second end of the fiber is optically coupled to an external optical source connector.

7. The photonic package of claim 6, wherein the first connector and the second connector are further coupled by a fastener.

8. A photonic package, comprising:
a substrate including a dielectric material with conductive pathways;
a photonic integrated circuit (PIC) having a first optical element, the PIC electrically coupled to the substrate;
a connector including:
a fiber alignment structure; and
a second optical element, wherein the second optical element includes an expanded beam lens, and wherein a material of the connector includes a fused silica glass, an optical grade polymer, or a combination thereof; and
a fiber having a first end and an opposing second end, wherein the fiber is positioned in the fiber alignment structure, and wherein the first end of the fiber is optically coupled to the first optical element and the second end of the fiber is optically coupled to the second optical element.

9. The photonic package of claim 8, wherein the connector has a length between 5 millimeters and 10 millimeters, a width between 3 millimeters and 8 millimeters, and a thickness between 0.5 millimeters and 2 millimeters.

10. The photonic package of claim 8, wherein the connector is a unitary part.

11. The photonic package of claim 8, wherein the connector further includes a connector alignment feature.

12. The photonic package of claim 11, wherein the connector alignment feature includes a first post and a second post, or a first socket and a second socket.

13. The photonic package of claim 11, wherein the connector is a first connector having a first fiber alignment structure and a first connector alignment feature, and the fiber is a first fiber, and the photonic package, further comprising:
a second connector including:
a second fiber alignment structure;
a third optical element at a lateral surface of the second fiber alignment structure, wherein the third optical element is to expand and collimate an optical beam; and
a second connector alignment feature, wherein the second connector is coupled to the first connector by the first and second connector alignment features with the third optical element facing the second optical element; and
a second fiber having a first end and an opposing second end, wherein the second fiber is mounted in the second fiber alignment structure, and wherein the first end of the second fiber is optically coupled to the third optical element and the second end of the fiber is optically coupled to an external optical source connector.

14. The photonic package of claim 13, wherein the first connector and the second connector are further coupled by a fastener.

15. A photonic package, comprising:
a substrate including a dielectric material with conductive pathways;
a photonic integrated circuit (PIC) including a first optical element, wherein the PIC is electrically coupled to one or more of the conductive pathways in the substrate;
a fiber having a first end and an opposing second end;
a first fiber alignment structure, wherein the fiber is positioned in the first fiber alignment structure and the first end of the fiber is optically coupled to the first optical element; and
a connector including:
a second fiber alignment structure; and
a second optical element, wherein the second optical element includes an expanded beam lens, wherein the fiber is positioned in the second fiber alignment structure and the second end of the fiber is optically coupled to the second optical element, and wherein a material of the connector includes a fused silica glass, an optical grade polymer, a 3-dimensional (3D) printing optical polymer, a 3D printing grade glass, or a 3D printing optical resin.

16. The photonic package of claim 15, wherein the connector has a length between 5 millimeters and 10 millimeters, a width between 3 millimeters and 8 millimeters, and a thickness between 0.5 millimeters and 2 millimeters.

17. The photonic package of claim 15, wherein the connector is physically coupled to the substrate.

18. The photonic package of claim 15, further comprising:
a heat spreader, wherein the connector is physically coupled to the heat spreader.

19. The photonic package of claim 15, further comprising:
a stiffener, wherein the connector is physically coupled to the stiffener.

20. The photonic package of claim 15, wherein the connector further includes a connector alignment feature.
